(19) United States
(12) Patent Application Publication
(10) Pub. No.: US 2016/0366707 A1
(43) Pub. Date: Dec. 15, 2016

(54) APPARATUS, SYSTEM AND METHOD OF SECURING COMMUNICATIONS OF A USER EQUIPMENT (UE) IN A WIRELESS LOCAL AREA NETWORK

(71) Applicant: INTEL IP CORPORATION, Santa Clara, CA (US)

(72) Inventors: Alexander Sirotkin, Giv'on Hachadasha (IL); Alexandre S. Stojanovski, Paris (FR); Jing Zhu, Portland, OR (US); Pingping Zong, Randolph, NJ (US); Nageen Himayat, Fremont, CA (US)

(21) Appl. No.: 15/121,059

(22) PCT Filed: Mar. 24, 2015
(86) PCT No.: PCT/US15/22125

§ 371 Date: Aug. 24, 2016

Related U.S. Application Data
(60) Provisional application No. 61/969,780, filed on Mar. 24, 2014.

(51) Int. Cl. H04W 76/02; H04W 12/04; H04W 12/06; H04W 12/02

(52) U.S. Cl. CPC H04W 76/02; H04W 12/02; H04W 12/04; H04W 12/06; H04W 84/12

(57) ABSTRACT

Some demonstrative embodiments include devices, systems of securing communications of a User Equipment (UE) in a Wireless Local Area Network (WLAN). For example, a UE may include a WLAN transceiver; a cellular transceiver to communicate with an evolved Node B (eNB) of a cellular network; and a controller to determine a UE security key based on a cellular security key corresponding to the eNB, and to establish a connection with a WLAN access device based on the UE security key.

### CROSS REFERENCE

This application claims the benefit of and priority from U.S. Provisional Patent Application No. 61/969,780 entitled “WLAN Authentication and Encryption Options for Integrated LTE/WLAN RATS”, filed Mar. 24, 2014, the entire disclosure of which is incorporated herein by reference.

### TECHNICAL FIELD

Some embodiments described herein generally relate to securing communications of a User Equipment (UE) in a wireless local area network (WLAN).

### BACKGROUND

A wireless communication device, e.g., a mobile device, may be configured to utilize multiple wireless communication technologies.

For example, a User Equipment (UE) device may be configured to utilize a cellular connection, e.g., a Long Term Evolution (LTE) cellular connection, as well as a wireless-local-area-network (WLAN) connection, e.g., a Wireless-Fidelity (WiFi) connection.

There exists a need for solutions to enhance a level of cooperation and/or integration between WLAN and cellular networks. For example, 3rd Generation Partnership Project (3GPP) TR 37.834 (“Technical Specification Group Radio Access Network; WLAN/3GPP Radio Interworking (Release 12)”), relates to potential Radio Access Network (RAN) level enhancements for WLAN/3GPP Interworking. The 3GPP specifies several features for 3GPP-WLAN interworking.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic illustration of a method of securing communications of a UE in a WLAN, in accordance with some demonstrative embodiments.

FIG. 3 is a schematic illustration of a method of securing communications of a UE in a WLAN, in accordance with some demonstrative embodiments.

FIG. 4 is a schematic illustration of a method of securing communications of a UE in a WLAN, in accordance with some demonstrative embodiments.

FIG. 5 is a schematic illustration of a product, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment,” “an embodiment,” “demonstrative embodiment,” “various embodiments,” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a Smartphone device, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wireless node, a base station (BS), a wired or wireless router, a wired or wireless modem, a video device, an audio device, an audio-video (A/V) device, a wired or wireless network, a wireless area network, a cellular network, a cellular node, a cellular device, a Wireless Local Area Network (WLAN), a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, vending machines, sell terminals, and the like.

Some embodiments may be used in conjunction with devices and/or networks operating in accordance with existing Long Term Evolution (LTE) specifications (including TS 36.300 (“3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2”, V12.1.0, June 2013); 3GPP TS 36.331 (3GPP TS 36.331 V11.5.0 (September 2013); Technical Specification; 3rd Generation Partnership Project; Technical Specification Group Radio Access Network; Evolved Universal Terrestrial Radio Access (E-UTRA); Radio Resource Control (RRC); Protocol specification (Release 11)); 3GPP TS 36.321 (3GPP TS 36.321 V11.4.0 (December 2013); Technical Specification 3rd Generation Partnership Project; Technical Specification Group Radio Access Network; Evolved Universal Terrestrial Radio Access (E-UTRA); Medium Access Control (MAC) protocol specification (Release 11)); 3GPP TS 36.322 (3GPP TS 36.322 V11.0.0 (September 2012); Technical Specification; 3rd Generation Partnership Project; Technical Specification Group Radio Access Network; Evolved Universal Terrestrial Radio Access (E-UTRA); Radio Link Control (RLC) protocol specification (Release 11)); 3GPP TS 36.323 (3GPP TS 36.323 V11.2.0 (March 2013); Technical Specification; 3rd Generation Partnership Project; Technical Specification Group Radio Access Network; Evolved Universal Terrestrial Radio Access (E-UTRA); Packet Data Convergence Protocol (PDCP) specification (Release 11)); 3GPP TS 36.413 (3GPP TS 36.413 V12.0.0 (December 2013); Technical Specification; 3rd Generation Partnership Project; Technical Specification Group Radio Access Network; Evolved Universal Terrestrial Radio Access Network (E-UTRAN); S1 Application Protocol (S1AP) (Release 12)); and TS 36.423 (“Evolved Universal Terrestrial Radio Access Network (E-UTRAN); X2 Application Protocol (X2AP)”)) and/or future versions and/or derivatives thereof, devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012), and/or future versions and/or derivatives thereof, devices and/or networks operating in accordance with existing IEEE 802.16 standards (IEEE-Std 802.16, 2009 Edition, Air Interface for Fixed Broadband Wireless Access Systems; IEEE-Std 802.16e, 2005 Edition, Physical and Medium Access Control Layers for Combined Fixed and Mobile Operation in Licensed Bands; amendment to IEEE Std 802.16-2009, developed by Task Group m) and/or future versions and/or derivatives thereof, devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing WirelessHD™ specifications and/or future versions and/or derivatives thereof, units and/or devices which are part of the above networks, and the like.

Some embodiments may be used in conjunction with one or more types of wireless communication signals and/or systems, for example, Radio Frequency (RF), Frequency-Division Multiplexing (FDM), Orthogonal FDM (OFDM), Orthogonal Frequency-Division Multiple Access (OFDMA), Spatial Divisional Multiple Access (SDMA), Multi-User (MU) MIMO (MU-MIMO), Single Carrier Frequency Division Multiple Access (SC-FDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wireless Fidelity (Wi-Fi), Wi-Max, ZigBee™, Ultra-Wideband (UWB), Global System for Mobile communication (GSM), second generation (2G), 2.5G, 3G, 3.5G, 4G, 4.5G, Fifth Generation (5G) mobile networks, 3GPP, Long Term Evolution (LTE) cellular system, LTE advance cellular system, High-Speed Downlink Packet Access (HSDPA), High-Speed Uplink Packet Access (HSUPA), High-Speed Packet Access (HSPA), HSPA+, Single Carrier Radio Transmission Technology (1×RTT), Evolution-Data Optimized (EV-DO), Enhanced Data rates for GSM Evolution (EDGE), and the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb “communicating” may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

Some demonstrative embodiments are described herein with respect to a LTE network. However, other embodiments may be implemented in any other suitable cellular network or system, e.g., a Universal Mobile Telecommunications System (UMTS) cellular system, a GSM network, a 3G cellular network, a 4G cellular network, a 4.5G network, a 5G cellular network, a WiMax cellular network, and the like.

Some demonstrative embodiments are described herein with respect to a WLAN system. However, other embodiments may be implemented in any other non-cellular network, for example, a millimeter Wave (mmWave) network, or a Wireless Gigabyte (WiGig) network.

Some demonstrative embodiments are described herein with respect to an Access Point (AP). However, other embodiments may be implemented in any other WLAN access device, for example, an Access Controller (AC), e.g., as described below.

Some demonstrative embodiments are described herein with respect to an evolved Node B (eNB). However, other embodiments may be implemented in any other cellular manager, for example, a Radio Network Controller (RNC), e.g., as described below.

Some demonstrative embodiments may be used in conjunction with a Heterogeneous Network (HetNet), which may utilize a deployment of a mix of technologies, frequencies, cell sizes and/or network architectures, e.g., including cellular, millimeter-wave (mmWave), and/or the like. In one example, the HetNet may include a radio access network having layers of different-sized cells ranging from large macrocells to small cells, for example, picocells and femtocells. Other embodiments may be used in conjunction with any other suitable wireless communication network.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a dipole antenna, a set of switched beam antennas, and/or the like.

The term “cell”, as used herein, may include a combination of network resources, for example, downlink and optionally uplink resources. The resources may be controlled and/or allocated, for example, by a cellular node (also referred to as a “base station”), or the like. The linking between a carrier frequency of the downlink resources and a carrier frequency of the uplink resources may be indicated in system information transmitted on the downlink resources.

The phrases “WLAN access device” and “WLAN manager” as used herein, may refer to an entity capable of controlling and/or managing WLAN radio access to one or more distribution networks or services. In some embodiments, the WLAN access device may include a WLAN Access Point (AP), e.g., as described below. In one example, the WLAN AP may include an entity that includes a station (STA) and provides access to distribution services, via the Wireless Medium (WM) for associated STAs. In other embodiments, the WLAN access device may include an Access Controller (AC), or any other device.

The term “station” (STA), as used herein, may include any logical entity that is a singly addressable instance of a medium access control (MAC) and a physical layer (PHY) interface to the WM.

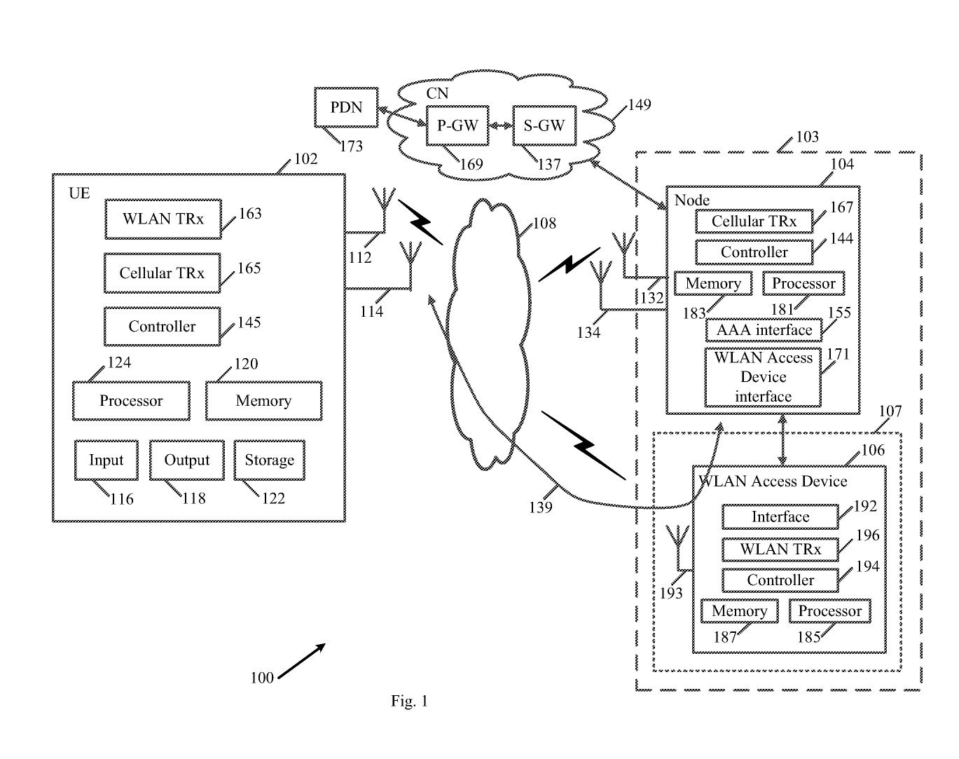

Reference is now made to FIG. 1, which schematically illustrates a block diagram of a system 100, in accordance with some demonstrative embodiments.

As shown in FIG. 1, in some demonstrative embodiments, system 100 may include one or more wireless communication devices capable of communicating content, data, information and/or signals via one or more wireless mediums 108. For example, system 100 may include at least one User Equipment (UE) 102 capable of communicating with one or more wireless communication networks, e.g., as described below.

Wireless mediums 108 may include, for example, a radio channel, a cellular channel, an RF channel, a WLAN channel, a Wireless Fidelity (WiFi) channel, a mmWave channel, a WiGig channel, an IR channel, and the like. One or more elements of system 100 may optionally be capable of communicating over any suitable wired communication links.

In some demonstrative embodiments, system 100 may include at least one cellular network, e.g., including a cell controlled by a cellular node (“node”) 104.

In some demonstrative embodiments, system 100 may include a non-cellular network 107, for example, a WLAN, e.g., a Basic Service Set (BSS), managed by a WLAN access device 106, e.g., a WLAN Access Point (AP), or a WLAN Access Controller (AC).

In some demonstrative embodiments, non-cellular network 107 may at least partially be within a coverage area of node 104. For example, WLAN access device 106 may be within a coverage area of node 104.

In some demonstrative embodiments, node 104 may perform the functionality of a cellular manager to control and/or manage communication of UE 102 in cell 103, e.g., as described below.

In some demonstrative embodiments, node 104 may include an Evolved Node B (eNB), e.g., in a LTE system. For example, node 104 may be configured to perform radio resource management (RRM), radio bearer control, radio admission control (access control), connection mobility management, resource scheduling between UEs and eNB radios, e.g., Dynamic allocation of resources to UEs in both uplink and downlink, header compression, link encryption of user data streams, packet routing of user data towards a destination, e.g., another eNB or an Evolved Packet Core (EPC), scheduling and/or transmitting paging messages, e.g., incoming calls and/or connection requests, broadcast information coordination, measurement reporting, and/or any other operations.

In other embodiments, node 104 may include any other functionality and/or may perform the functionality of any other cellular node, e.g., a Node B (NB), a Radio Network Controller (RNC) configured to control at least one Node B, a base station or any other node or device.

In some demonstrative embodiments, UE 102 may include, for example, a mobile computer, a MD, a STA, a laptop computer, a notebook computer, a tablet computer, an Ultrabook™ computer, a mobile internet device, a handheld computer, a handheld device, a storage device, a PDA device, a handheld PDA device, an Internet of Things (IoT) device, an on-board device, an off-board device, a hybrid device (e.g., combining cellular phone functionalities with PDA device functionalities), a consumer device, a vehicular device, a non-vehicular device, a mobile or portable device, a mobile phone, a cellular telephone, a PCS device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a video device, an audio device, an A/V device, a gaming device, a media player, a Smartphone, or the like.

In some demonstrative embodiments, UE 102, node 104 and/or WLAN access device 106 may include one or more wireless communication units and/or modules to perform wireless communication between UE 102, node 104, WLAN access device 106 and/or with one or more other wireless communication devices, e.g., as described below.

In some demonstrative embodiments, UE 102 may include a WLAN Transceiver (TRx) 163, and a cellular TRx 165; WLAN access device 106 may include a WLAN TRx 196; and/or node 104 may include a cellular TRx 167, e.g., as described below.

In some demonstrative embodiments, node 104 may include cellular TRx 167 to communicate directly with UE 102 via a cellular link, for example, if node 104 performs the functionality of an eNB, e.g., as described below. However, in other embodiments, node 104 may include any other communication interface, in addition to or instead of cellular TRx 167, to communicate with UE 102 via a cellular link, e.g., directly or indirectly. In one example, node 104 may perform the functionality of a RNC. According to this example, node 104 may include a Node B interface, e.g., an Interface Unit b (Iub), to communicate with UE 102 via a Node B, which may include a cellular TRx 167, e.g., via a cellular link between the Node B and UE 102.

In some demonstrative embodiments, WLAN access device 106 may include WLAN TRx 196 to communicate directly with UE 102 via a WLAN link, e.g., as described below. However, in other embodiments, WLAN access device 106 may include any other communication interface, in addition to or instead of WLAN TRx 196, to communicate with UE 102 via a WLAN link, e.g., directly or indirectly. In one example, WLAN access device 106 may perform the functionality of an Access Controller (AC). According to this example, WLAN access device 106 may include a Lightweight AP (LAP) interface to communicate with UE 102 via a LAP, which may include WLAN TRx 196, e.g., via a WLAN link between the LAP and UE 102.

In some demonstrative embodiments, UE 102, node 104 and/or WLAN access device 106 may include, or may be associated with, one or more antennas. In one example, UE 102 may be associated with at least two antennas, e.g., antennas 112 and 114, or any other number of antennas, e.g., one antenna or more than two antennas; node 104 may be associated with at least two antennas, e.g., antennas 132 and 134, or any other number of antennas, e.g., one antenna or more than two antennas; and/or WLAN access device 106 be associated with one or more antennas 193.

In some demonstrative embodiments, antennas 112, 114, 132, 134 and/or 193 may include any type of antennas suitable for transmitting and/or receiving wireless communication signals, blocks, frames, transmission streams, packets, messages and/or data. For example, antennas 112, 114, 132, 134 and/or 193 may include any suitable configuration, structure and/or arrangement of one or more antenna elements, components, units, assemblies and/or arrays. For example, antennas 112, 114, 132, 134 and/or 193 may include a phased array antenna, a dipole antenna, a single element antenna, a set of switched beam antennas, and/or the like.

In some embodiments, antennas 112, 114, 132, 134 and/or 193 may implement transmit and receive functionalities using separate transmit and receive antenna elements. In some embodiments, antennas 112, 114, 132, 134 and/or 193 may implement transmit and receive functionalities using common and/or integrated transmit/receive elements.

In some demonstrative embodiments, cellular TRx 165, WLAN TRx 163, cellular TRx 167, and/or WLAN TRx may include one or more wireless transmitters, receivers and/or transceivers including circuitry and/or logic configured to send and/or receive wireless communication signals, RF signals, frames, blocks, transmission streams, packets, messages, data items, and/or data.

In some demonstrative embodiments, WLAN TRx 147 and WLAN TRx 196 may be configured to communicate between UE 102 and WLAN access device 106 over a WLAN link; and/or cellular TRx 165 and cellular TRx 167 may be configured to communicate between UE 102 and node 104 over a cellular link.

In some demonstrative embodiments, the WLAN link may include, for example, a Wireless Fidelity (WiFi) link, a mmWave link, a Wireless Gigabit (WiGig) link, or any other link. In some demonstrative embodiments, the WLAN link may include, for example, a link over the 2.4 Gigahertz (GHz) or 5 GHz frequency band, the 60 GHz frequency band, or any other frequency band.

In some demonstrative embodiments, cellular TRx 165 and/or cellular TRx 167 may include a multiple input multiple output (MIMO) transmitters receivers system (not shown), which may include circuitry and/or logic capable of performing antenna beamforming methods, if desired. In other embodiments, cellular TRx 165 and/or cellular TRx 167 may include any other transmitters and/or receivers.

In some demonstrative embodiments, cellular TRx 165 and/or cellular TRx 167 may include a turbo decoder and/or a turbo encoder (not shown) for encoding and/or decoding data bits into data symbols, if desired. In other embodiments, cellular TRx 165 and/or cellular TRx 167 may include any other encoder and/or decode.

In some demonstrative embodiments, cellular TRx 165 and/or cellular TRx 167 may include OFDM and/or SC-FDMA modulators and/or demodulators (not shown) configured to communicate OFDM signals over downlink channels, e.g., between node 104 and UE 102, and SC-FDMA signals over uplink channels, e.g., between UE 102 and node 104. In other embodiments, cellular TRx 165 and/or cellular TRx 167 may include any other modulators and/or demodulators.

In some demonstrative embodiments, WLAN TRx 163 and/or WLAN TRx 196 may establish a WLAN link between UE 102 and WLAN access device 106. For example, WLAN TRx 163 may perform the functionality of one or more STAs, e.g., one or more WiFi STAs, WLAN STAs, and/or millimeter Wave (mmWave) STAs. The WLAN link may include an uplink and/or a downlink. The WLAN downlink may include, for example, a unidirectional link from WLAN access device 106 to the one or more STAs. The uplink may include, for example, a unidirectional link from a STA to WLAN access device 106.

In some demonstrative embodiments, UE 102 may include a controller 145 to control one or more functionalities of UE 102, node 104 may include a controller 144 to control one or more functionalities of node 104, and/or WLAN access device 106 may include a controller 194 to control one or more functionalities of WLAN access device 106, e.g., as described below.

In some demonstrative embodiments, controller 145, controller 144, and/or controller 194 may include or may be implemented using suitable circuitry and/or logic, e.g., controller circuitry and/or logic, processor circuitry and/or logic, memory circuitry and/or logic, and/or any other circuitry and/or logic, which may be configured to perform at least part of the functionality of controller 145, controller 144, and/or controller 194. Additionally or alternatively, one or more functionalities of controller 145, controller 144, and/or controller 194 may be implemented by logic, which may be executed by a machine and/or one or more processors, e.g., as described below.

In some demonstrative embodiments, UE 102 may also include, for example, one or more of a processor 124, an input unit 116, an output unit 118, a memory unit 120, and a storage unit 122; node 104 may include a processor 181 and/or a memory 183; and/or AP 106 may include a processor 185 and/or a memory 187. UE 102, node 104 and/or WLAN access device 106 may optionally include other suitable hardware components and/or software components. In some demonstrative embodiments, some or all of the components of one or more of UE 102, node 104 and/or WLAN access device 106 may be enclosed in a common housing or packaging, and may be interconnected or operably associated using one or more wired or wireless links. In other embodiments, components of one or more of UE 102, node 104 and/or WLAN access device 106 may be distributed among multiple or separate devices.

Processor 124, processor 181, and/or processor 185 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 124 executes instructions, for example, of an Operating System (OS) of UE 102 and/or of one or more suitable applications. Processor 181 executes instructions, for example, of an OS of node 104 and/or of one or more suitable applications. Processor 185 executes instructions, for example, of an OS of WLAN access device 106 and/or of one or more suitable applications.

Input unit 116 includes, for example, a keyboard, a keypad, a mouse, a touch-screen, a touch-pad, a track-ball, a stylus, a microphone, or other suitable pointing device or input device. Output unit 118 includes, for example, a monitor, a screen, a touch-screen, a flat panel display, Light Emitting Diode (LED) display unit, a Liquid Crystal Display (LCD) display unit, a plasma display unit, one or more audio speakers or earphones, or other suitable output devices.

Memory unit 120 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 122 includes, for example, a hard disk drive, a floppy disk drive, a Compact Disk (CD) drive, a CD-ROM drive, a DVD drive, or other suitable removable or non-removable storage units. Memory unit 120 and/or storage unit 122, for example, may store data processed by UE 102. Memory 183 may store, for example, data processed by node 104. Memory 187 may store, for example, data processed by WLAN access device 106.

In some demonstrative embodiments, UE 102 may be configured to utilize a cellular connection, e.g., a Long Term Evolution (LTE) cellular connection, a Universal Mobile Telecommunications System (UMTS) connection or any other cellular connection, to communicate with node 104; and a WLAN connection, e.g., a Wireless-Fidelity (WiFi) connection or any other WLAN connection, to communicate with WLAN access device 106.

In some demonstrative embodiments, one or more elements of system 100 may perform the functionality of a HetNet, which may utilize a deployment of a mix of technologies, frequencies, cell sizes and/or network architectures, for example, including cellular, WLAN, and/or the like.

For example, the HetNet may be configured to provide a service through a first wireless communication environment, e.g., a cellular network, and to maintain the service when switching to another communication environment, e.g., WLAN. The HetNet architecture may enable utilizing a mixture of wireless communication environments, e.g., a WLAN environment and a cellular environment, for example, to optimally respond to rapid changes in customer demand, reduce power consumption, reduce cost, increase efficiency and/or achieve any other benefit.

In one example, system 100 may utilize a Multi-tier, Multi Radio Access technology (Multi-RAT) Het-Net architecture, including a tier of small cells, e.g., pico, femto, relay stations, WiFi APs, and the like, overlaid on top of a macro cellular deployment to augment network capacity.

In another example, system 100 may utilize Multi-RAT small cells integrating multiple radios such as WiFi and 3GPP air interfaces in a single infrastructure device.

In some demonstrative embodiments, node 104 and WLAN access device 106 may be implemented as part of a Multi-RAT small cell.

In some demonstrative embodiments, node 104 and WLAN access device 106 may be co-located or connected as part of an Integrated Cellular and WLAN (ICW) multi-RAT small cell.

In some demonstrative embodiments, node 104 and WLAN access device 106 may be configured to interface with one another, for example, to enable node 104 to interact directly with WLAN access device 106 and/or to control one or more functionalities of WLAN access device 106, e.g., as described below.

In some demonstrative embodiments, node 104 may include an access device interface 171 to communicate with WLAN access device 106, and/or WLAN access device 106 may include a cellular manager interface 192 to communicate with node 104, e.g., as described below.

In some demonstrative embodiments, interfaces 171 and 192 may include any suitable interface configured to provide connectivity between WLAN access device 106 and node 104. Interfaces 171 and 196 may include any wired and/or wireless communication links. In one example, interfaces 171 and 196 may be configured to route and/or tunnel communications between node 104 and WLAN access device 106. For example, interfaces 171 and 196 may include an Internet-Protocol (IP) based network, or any other network.

In some embodiments, node 104 and WLAN access device 106 may be implemented in the form of a coupled eNB/WLAN access device, e.g., a coupled eNB/AP.

In some demonstrative embodiments, the coupled eNB/AP may include eNB circuitry configured to perform the functionality of node 104, and WLAN access device circuitry, e.g., AP circuitry configured to perform the functionality of WLAN access device 106, e.g., as described below.

In some embodiments, node 104 and WLAN access device 106 may be implemented as part of a common device, e.g., an integrated eNB/AP device. In other embodiments, node 104 and WLAN access device 106 may be implemented as separate and/or independent units or devices. For example, the coupled eNB/AP may include separate eNB and AP devices, which may be coupled together.

In other embodiments, system 100 may implement any other architecture and/or deployment.

In some demonstrative embodiments, UE 102 may establish a plurality of Evolved Packet-switched System (EPS) bearers to connect between UE 102 and one or more elements of a Core Network (CN) 149 via node 104.

In one example, UE 102 may establish at least one Packet Data Network (PDN) connection between UE 102 and at least one PDN 173, e.g., to support one or more EPS bearers between UE 102 and the PDN 173. The PDN connection may be maintained over a plurality of bearers between UE 102 and the PDN 173. PDN 173 may include, for example, an Internet network, an IP Multimedia Core Network Subsystem (IMS) network, and/or any other network.

In one example, system 100 may include an LTE system, and at least one EPS bearer may be established via the PDN connection between UE 102 and a PDN Gateway (GW) (P-GW) 169 of CN 149. The EPS bearer may include a Data Radio Bearer (DRB) between UE 102 and node 104, a bearer, e.g., a S1 bearer, between node 104 and a Serving Gateway (S-GW) 137 of CN 149, and a bearer, e.g., a S5 bearer, between the S-GW 137 and the P-GW 169. In some implementations, an Evolved UMTS Terrestrial Radio Access Network (E-UTRAN) Radio Access Bearer (E-RAB) may be established between UE 102 and the S-GW 167, e.g., including the DRB and the S1 bearer.

In some demonstrative embodiments, a bearer, e.g., the EPS bearer, may be in the form of a virtual connection, which may provide a bearer service, e.g., a transport service with specific Quality of Service (QoS).

In some demonstrative embodiments, node 104, WLAN access device 106, and/or UE 102 may be configured to enable cellular-WLAN interworking at the radio access network level, e.g., as described below.

In one example, node 104, WLAN access device 106, and/or UE 102 may be configured to provide improved traffic balancing between WLAN access of UE 102 and cellular access of UE 102. Additionally or alternatively, node 104, WLAN access device 106, and/or UE 102 may be configured to enable radio access selection taking into account radio congestion levels, e.g., of the cellular and WLAN links. Additionally or alternatively, node 104, WLAN access device 106, and/or UE 102 may be configured to provide improved battery life of UE 102, and/or to provide any other improvements and/or benefits.

In some demonstrative embodiments, node 104, WLAN access device 106, and/or UE 102 may be configured to enable a tightly coupled cellular-WLAN interworking system architecture, e.g., as described below. In some demonstrative embodiments, UE 102, cellular node 104 and/or WLAN access device 106 may be configured to communicate according to a LTE/WLAN protocol aggregation scheme, e.g., as described below.

In some demonstrative embodiments, the LTE/WLAN protocol stack aggregation may be configured to enable LTE interworking with a WLAN protocol stack.

In some demonstrative embodiments, the LTE/WLAN protocol stack aggregation may be configured to anchor WLAN mobility at the cellular node 104.

In some demonstrative embodiments, the WLAN link between UE 102 and WLAN access device 106 may be aggregated above a WLAN MAC layer.

In some demonstrative embodiments, the LTE/WLAN protocol stack aggregation may be configured to aggregate the WLAN protocol stack above an LTE Packet Data Convergence Protocol (PDCP) layer.

In some demonstrative embodiments, the LTE protocol stack aggregation may be configured to aggregate the WLAN protocol stack below the LTE PDCP layer.

In some demonstrative embodiments, the LTE/WLAN protocol stack aggregation may include an encapsulation protocol, which may be configured to encapsulate messages between UE 102 and cellular node 104, for example, via a tunnel, which may be set up between UE 102 and cellular node 104, for example through WLAN access device 106.

In some demonstrative embodiments, cellular node 104 and/or UE 102 may be configured to use a control protocol, for example, a Radio Resource Control (RRC) protocol and/or any other protocol, for example, to enable UE 102 and WLAN access device 106 to discover one another, and to set up and/or establish a WLAN link between UE 102 and WLAN access device 106.

In some demonstrative embodiments, node 104, WLAN access device 106, and/or UE 102 may be configured according to a Multi-Homed Radio Bearer (MHRB) architecture, including a plurality of radio bearer connections (“radio bearer legs”) to communicate traffic of a DRB between node 104 and UE 102.

In other embodiments, node 104, WLAN access device 106, and/or UE 102 may be configured according to any other architecture.

In some demonstrative embodiments, the MHRB architecture may include two radio bearer legs, for example, including a first radio bearer leg, which may be established over the cellular link between node 104 and UE 102, and a second radio bearer leg, which may be established over the WLAN link between UE 102 and WLAN access device 106. In some demonstrative embodiments, according to the MHRB architecture, the first and second radio bearer legs may be joined together at node 104, for example, in a manner transparent to elements of CN 149, e.g., as described below.

In some demonstrative embodiments, a single DRB may use both the WLAN link and the cellular link, e.g., simultaneously.

In some demonstrative embodiments, the radio bearer leg may be established in the form of a point to point (P2P) link between UE 102 and node 104, for example, over the WLAN link between UE 102 and WLAN access device 106.

In other embodiments, the radio bearer leg may be established in the form of a concatenation of a link between node 104 and WLAN access device 106, and a link between WLAN access device 106 and UE 102.

In some demonstrative embodiments, UE 102, node 104, and/or WLAN access device 106 may be configured to enable steering one or more DRBs between UE 102 and node 104 via at least one P2P link 139 between UE 102 and node 104, e.g., formed over the WLAN link between UE 102 and WLAN access device 106, e.g., as described below.

In some demonstrative embodiments, controller 144 may be configured to establish the at least one P2P link 139 with UE 102 via the WLAN link between UE 102 and WLAN access device 106.

In some demonstrative embodiments, node 104 may provide to UE 102 information corresponding to the at least one P2P link 139, for example, to enable UE 102 to establish the P2P link 139 with node 104. For example, node 104 may provide the information corresponding to the P2P link 139 to UE 102 via one or more Radio Resource Control (RRC) messages, which may be communicated over the cellular link between node 104 and UE 102. For example, cellular TRX 167 may send to UE 102 a RRC message including a request to establish the P2P link 139. For example, the RRC message may include WLAN identification information to identify WLAN access device 106, and a transport address of node 104. The transport address of node 104 may include, for example, an address of a termination port at node 104 to be used for the P2P link 139, or any other address to be used by node 104 for the P2P link 139. The WLAN identification information may include, for example, a name of WLAN access device 106, a Service Set Identifier (SSID) of WLAN access device 106, a Basic Service Set Identifier (BSSID) of WLAN access device 106, an address of AP 106, a Media Access Control (MAC) address of WLAN access device 106, or any other identifier to identify the WLAN controlled by WLAN access device 106. Cellular TRx 165 may receive the RRC message, and controller 145 may establish the P2P link 139 with node 104, e.g., based on the WLAN identification information and the transport address.

In some demonstrative embodiments, any other scheme, architecture and/or protocol may be additionally or alternatively implemented, e.g., as part of the LTE/WLAN protocol aggregation.

In some demonstrative embodiments, an unauthorized entity, for example, an unauthorized UE or any other device capable of communicating with WLAN access device 106, may attempt to mount an attack on node 104, e.g., via the WLAN link with WLAN access device 106. Such an attack on node 104 may, for example, potentially harm one or more elements of CN 149.

In some demonstrative embodiments, UE 102, node 104 and/or WLAN access device 106 may be configured to enable securing the WLAN link between UE 102 and WLAN access device 106.

In some demonstrative embodiments, securing the WLAN link may include authenticating the UE 102 at the WLAN access device 106, for example, to prevent an unauthorized STA from connecting to WLAN access device 106 and/or to the coupled eNB/AP.

In some demonstrative embodiments, securing the WLAN link may include encrypting communications over the WLAN link.

Some demonstrative embodiments may be implemented to authenticate UE 102 and/or secure communications of UE 102 over a P2P link, e.g., P2P link 139, between UE 102 and cellular node 104, e.g., as described below. Other embodiments may be implemented to establish any other WLAN link between UE 102 and WLAN access device 106, and/or to authenticate UE 102 and/or secure communications of UE 102 over any other WLAN link.

In some demonstrative embodiments, authenticating UE 102 using a WLAN authentication scheme, which relies on communication and/or interaction with CN 149, may be complex, may not be efficient, may not be optimal, and/or may affect a user Quality of Experience (QoE) of a user of UE 102, e.g., as described below.

In some demonstrative embodiments, a WLAN authentication scheme for 3GPP-WLAN interworking, e.g., as implemented by the 3GPP functionality defined in 3GPP TS 23.402, may be based on communications with a server, e.g., an Authentication, Authorization and Accounting (AAA) server, in CN 149. This WLAN authentication scheme may be complex, inefficient, and/or may not be suitable and/or optimal for some implementations, for example, implementations involving Radio Access Network (RAN) level interworking.

For example, an interface between node 104 and CN 149 may not be efficient, for example, as the interface introduce a delay, which may degrade a user Quality of Experience (QoE). In one example, e.g., in a RAN-level interworking implementation, an eNB, e.g., node 104, may interface a CN, e.g., CN 149, via an interface, e.g., an S1 interface, introduce a delay to performing an authentication procedure to authenticate a UE, e.g., UE 102.

Additionally or alternatively, a WLAN authentication scheme based on WLAN authentication via the server in the CN may impose an increasing burden on the CN, for example, as authentications may be frequent, e.g. due to UE mobility.

In some demonstrative embodiments, UE 102, node 104 and/or WLAN access device 106 may be configured to enable securing a WLAN connection with UE 102, e.g., by authenticating UE 102 and/or encrypting communications with UE 102, for example, even without involving CN 149, e.g., as described below.

In some demonstrative embodiments, one or more different security methods may be implemented with respect to an architecture implementing LTE protocol stack aggregation below the LTE PDCP layer, and to an architecture implementing LTE protocol stack aggregation above the LTE PDCP layer, e.g., as described below.

In some demonstrative embodiments, WLAN encryption may be used, for example, with respect to an architecture implementing LTE protocol stack aggregation above the LTE PDCP layer, e.g., as described below.

In some demonstrative embodiments, WLAN encryption may be used, for example, with respect to an architecture implementing LTE protocol stack aggregation below the LTE PDCP layer, e.g., as described below.

In some demonstrative embodiments, LTE encryption may be re-used, for example, with respect to an architecture implementing LTE protocol stack aggregation below the LTE PDCP layer.

In some demonstrative embodiments, UE 102, node 104 and/or WLAN access device 106 may be configured to secure the WLAN link between UE 102 and WLAN access device 106 according to one or more security schemes (also referred to as “solutions”), e.g., as described below.

In some demonstrative embodiments, UE 102, node 104 and/or WLAN access device 106 may be configured to secure the WLAN link between UE 102 and WLAN access device 106 according to a first security scheme (“Solution 1”), e.g., as described below.

In some demonstrative embodiments, the “Solution 1” scheme may be configured to be implemented, for example, when LTE protocol stack aggregation is above the LTE PDCP layer.

In some demonstrative embodiments, the “Solution 1” scheme may be configured to use a CN-based WLAN security scheme, e.g., as described below.

In some demonstrative embodiments, when the LTE protocol stack is aggregated above the PDCP layer, a WLAN security mechanism, for example, WPA Enterprise with EAP-SIM, or any other WLAN security mechanism, may be used. Such a solution may be advantageous, for example, as it may not have impact on current cellular and/or WLAN standards. However, such a solution may involved CN, and/or may result in the WLAN not being fully transparent to the EPC.

In some demonstrative embodiments, UE 102, node 104 and/or WLAN access device 106 may be configured to secure the WLAN link between UE 102 and WLAN access device 106 according to a second security scheme (“Solution 2”), e.g., as described below.

In some demonstrative embodiments, the “Solution 2” scheme may be configured to be implemented, for example, when LTE protocol stack aggregation is above the LTE PDCP layer.

In some demonstrative embodiments, the “Solution 2” scheme may be configured to use a security key, for example, for WLAN authentication and/or encryption, e.g., as described below. The security key may include, for example, a WLAN security key, a Pre-Shared Key (PSK), for example, a WiFi Protected Access (WPA) PSK, or any other key.

Some demonstrative embodiments are described herein with respect to using a PSK. In other embodiments, any other security key, for example, a WLAN security key, may be used.

In some demonstrative embodiments, at least one of cellular node 104 and WLAN access device 106 may be provided with a PSK, e.g., a WPA-PSK.

In one example, at least one of cellular node 104 and WLAN access device 106 may be provisioned with the PSK, e.g. via OAM.

In another example, at least one of cellular node 104 and WLAN access device 106 may randomly generate, e.g., possibly a one-time, PSK.

In another example, at least one of cellular node 104 and WLAN access device 106 may generate a unique WPA-PSK, e.g., for every UE.

In some demonstrative embodiments, the PSK may be communicated between cellular node 104 and WLAN access device 106, for example, via the interface between cellular nod 104 and WLAN access device 106. In one example, the PSK may be sent via an internal interface from WLAN access device 106 to cellular node 104, for example, if the PSK is generated at WLAN access device 106. In another example, the PSK may be sent via an internal interface from cellular node 104 to WLAN access device 106, for example, if the PSK is generated at cellular node 104. In another example, the PSK may be generated by separate module, e.g., separate from cellular node 104 and WLAN access device 106, and sent, e.g., via internal interfaces,) to both cellular node 104 and WLAN access device 106.

In some demonstrative embodiments, WLAN access device 106 may use the PSK, for example, for authentication and/or encryption.

In some demonstrative embodiments, WLAN access device 106 may be configured to support using one PSK, e.g., per SSID. According to these embodiments, unique keys for every UE may not be used.

In some demonstrative embodiments, WLAN access device 106 may be configured to support using multiple PSKs, e.g., for every user.

In some demonstrative embodiments, cellular node 104 may be configured to send the PSK to UE 102, for example, via RRC signaling or according to any other signaling protocol.

In some demonstrative embodiments, an LTE baseband in UE 102, e.g., a baseband of cellular TRx 165 and/or controller 145, may pass the PSK, e.g., via one or more internal interfaces, to a WLAN baseband of UE 102, e.g., a baseband of WLAN TRx 163.

In some demonstrative embodiments, UE 102, e.g., controller 145, may use the PSK, for example, to perform WLAN authentication and/or encryption, e.g., when communicating with WLAN access device 107 via the WLAN.

In some demonstrative embodiments, the “Solution 2” scheme may be advantageous, for example, as it may not require CN signaling and/or may not have substantial impact on cellular and/or WLAN standards.

In some demonstrative embodiments, a randomly generated one-time PSK may be, for example, more secure than a pre-provisioned PSK. Although, the PSK may use the same encryption as WPA Enterprise, which is considered secure enough in cellular systems, using a single PSK for all UEs may be less secure, for example, compared to using randomly generated one-time PSKs.

In some demonstrative embodiments, UE 102, node 104 and/or WLAN access device 106 may be configured to secure the WLAN link between UE 102 and WLAN access device 106 according to a third security scheme (“Solution 3”), e.g., as described below.

In some demonstrative embodiments, the “Solution 3” scheme may be configured to be implemented, for example, when LTE protocol stack aggregation is above the LTE PDCP layer.

In some demonstrative embodiments, node 104 and/or WLAN access device 106 may be configured to secure the WLAN link between UE 102 and WLAN access device 106 using a UE security key, e.g., as described below.

In some demonstrative embodiments, the UE security key may include pre-shared key (PSK).

In some demonstrative embodiments, UE security key may include Wireless-Fidelity Protected Access (WPA) PSK.

In other embodiments, the UE security key may include any other key.

In some demonstrative embodiments, controller 145 may be configured to authenticate UE 102 with WLAN access device 106, for example, based on the UE security key.

In some demonstrative embodiments, controller 145 may be configured to encrypt communications with WLAN access device 106, for example, based on the UE security key.

In some demonstrative embodiments, the UE security key may include a UE-specific security key, which may be specific to UE 102.

In some demonstrative embodiments, UE 102 and cellular node 104 may be configured to determine the UE security key, for example, independently from one another.

In some demonstrative embodiments, the UE security key may be determined by UE 102, for example, while not requiring the transferring of the UE security key from cellular node 104 to UE 102, for example, in opposed to the PSK of the Solution 2 scheme, which is communicated from the cellular node to the UE.

In some demonstrative embodiments, controller 145 may be configured to determine the UE security key based on a cellular security key corresponding to cellular node 104, e.g., as described below.

In some demonstrative embodiments, controller 145 may be configured to establish a connection with WLAN access device 106, for example, based on the UE security key, e.g., as described below.

In some demonstrative embodiments, controller 145 may be configured to authenticate UE 102 with WLAN access device 106, for example, based on the UE security key.

In some demonstrative embodiments, controller 145 may be configured to encrypt communications with WLAN access device 106, for example, based on the UE security key.

In some demonstrative embodiments, controller 145 may be configured to determine the UE security key based on a cellular security key including an eNB security key, denoted K_{eNB}, corresponding to cellular node 104, e.g., as described below. In other embodiments, controller 145 may be configured to determine the UE security key based on any other additional or alternative key and/or information corresponding to cellular node 104 and/or to WLAN access device 106.

In some demonstrative embodiments, UE 102 may be configured to determine the security key K_{eNB}, for example, based on a Access Security Management Entity (ASME) key denoted K_{ASME}.

In one example, controller 145 may be configured to determine the key K_{eNB} corresponding to cellular node 104, for example, upon handover of UE 102 to the cell being controlled by cellular node 104.

In other embodiments, UE 102 may be configured to determine the security key K_{eNB}, for example, based on any other key or information.

In some demonstrative embodiments, controller 144 may be configured to determine the UE security key corresponding to UE 102, for example, based on the cellular security key corresponding to cellular node 104.

In some demonstrative embodiments, controller 144 may be configured to determine the UE security key corresponding to UE 102, for example, independently from the determination of the UE security key at UE 102.

In some demonstrative embodiments, controller 144 may be configured to determine the UE security key based on a cellular security key including the key K_{eNB} corresponding to cellular node 104. In other embodiments, controller 144 may be configured to determine the UE security key based on any other additional or alternative key and/or information corresponding to cellular node 104 and/or to WLAN access device 106.

In some demonstrative embodiments, controller 144 may be provided with the security key K_{eNB}, which may be based, for example, on the key K_{ASME}.

In one example, cellular node 104 may be configured to receive the key K_{eNB} corresponding to cellular node 104, for example, from a network entity in CN 149, e.g., a Mobility Management Entity (MME), for example, upon handover of UE 102 to the cell being controlled by cellular node 104.

In other embodiments, the key K_{eNB} corresponding to cellular node 104 may be determined and/or provided to controller 144, for example, based on any other key or information.

In some demonstrative embodiments, cellular node 104 may send the UE security key corresponding to UE 102 to WLAN access device 106, e.g., via WLAN access device interface 171.

In some demonstrative embodiments, controller 144 may cause access device interface 171 to send to WLAN access device 106 security information corresponding to the UE 102. For example, the security information may include a WLAN identifier of the UE 102 and the UE security key corresponding to the UE 102.

In some demonstrative embodiments, WLAN access device 106 may receive the WLAN security information from cellular node 104, e.g., via interface 192.

In some demonstrative embodiments, controller 194 may use the security information to authenticate an attempt of UE 102 to associate with WLAN access device 106 and/or to encrypt communications between WLAN access device 106 and UE 102.

In some demonstrative embodiments, controller 144 and/or controller 145 may be configured to determine the UE security key corresponding to UE 102, for example, based on one or more parameters corresponding to UE 102, one or more parameters corresponding to WLAN access device 106, and/or one or more parameters corresponding to cellular node 104, e.g. as described below.

In some demonstrative embodiments, determining the UE security key corresponding to UE 102 based on one or more parameters corresponding to UE 102 may enable, for example, to generate a UE security key which may be specific to UE 102, for example, to enable using different UE security keys for different UEs.

In some demonstrative embodiments, determining the UE security key corresponding to UE 102 based on one or more parameters corresponding to WLAN access device 106 may enable, for example, to generate a UE security key which may be specific to WLAN access device 106, for example, to enable using different UE security keys for different WLAN access devices.

In some demonstrative embodiments, determining the UE security key corresponding to UE 102 based on one or more parameters corresponding to cellular node 104 may enable, for example, to generate a UE security key which may be specific to cellular node 104, for example, to enable using different UE security keys for different cellular nodes.

In some demonstrative embodiments, controller 145 may be configured to determine the UE security key corresponding to UE 102, for example, based on an identifier of WLAN access device 106.

In some demonstrative embodiments, controller 144 may be configured to determine the UE security key corresponding to UE 102, for example, based on an identifier of WLAN access device 106.

In some demonstrative embodiments, the identifier of the WLAN access device 106 may include a Media Access Control (MAC) address of WLAN access device 106, a Service Set Identifier (SSID) of WLAN access device 106, and/or any other identifier.

In some demonstrative embodiments, UE 102 may receive the identifier of WLAN access device 106, for example, from cellular node 104.

In some demonstrative embodiments, controller 144 may be configured to cause cellular TRx 167 to transmit to UE 102 a message including the identifier of WLAN access device 106.

In some demonstrative embodiments, controller 144 may be configured to cause cellular TRx 167 to transmit to UE 102 a Radio Resource Control (RRC) message including the identifier of WLAN access device 106. In other embodiments, the identifier of WLAN access device 106 may be sent via any other type of message.

In some demonstrative embodiments, cellular transceiver 165 may receive the message, e.g., the RRC message, including the identifier of WLAN access device 106, and controller 145 may determine the UE security key corresponding to UE 102, based on the identifier of WLAN access device 106.

In some demonstrative embodiments, controller 145 may be configured to determine the UE security key corresponding to UE 102, for example, based on an identifier of UE 102.

In some demonstrative embodiments, controller 144 may be configured to determine the UE security key corresponding to UE 102, for example, based on an identifier of UE 102.

In some demonstrative embodiments, the identifier of UE 102 may include a Media Access Control (MAC) address of UE 102, and/or any other identifier.

In some demonstrative embodiments, cellular node 104 may receive the identifier of UE 102, for example, from UE 102.

In some demonstrative embodiments, controller 145 may be configured to cause cellular TRx 165 to transmit to cellular node 104 a message including the identifier of UE 102.

In some demonstrative embodiments, controller 145 may be configured to cause cellular TRx 165 to transmit to cellular node 104 a RRC message including the identifier of UE 102. In other embodiments, the identifier of UE 102 may be sent via any other type of message.

In some demonstrative embodiments, cellular transceiver 167 may receive the message, e.g., the RRC message, including the identifier of UE 102, and controller 144 may determine the UE security key corresponding to UE 102, based on the identifier of UE 102.

In some demonstrative embodiments, an integrated eNB/AP may include an eNB, e.g., cellular node 104, coupled to WLAN access device, e.g., WLAN access device 106, as described above. The eNB, e.g., cellular node 104 may generate a WPA-PSK corresponding to UE 102, for example, based on the key K_{eNB}, e.g., as described above.

In some demonstrative embodiments, the eNB, e.g., cellular node 104, may pass the WPA-PSK corresponding to UE 102, to the AP, for example, an integrated AP, which may be coupled to the eNB, e.g., WLAN access device 104, for example, via an internal interface, e.g., interfaces 171 and 192.

In some demonstrative embodiments, UE 102 may generate the WPA-PSK corresponding to UE 102, for example, based on the key K_{eNB}, e.g., as described above.

In some demonstrative embodiments, the LTE baseband in UE 102, e.g., the baseband of controller 145, may pass the WPA-PSK corresponding to UE 102 to an integrated WLAN baseband of UE 102.

In some demonstrative embodiments, the eNB/AP and the UE 102 may use the WPA-PSK corresponding to UE 102, for example, to perform WLAN authentication and/or encryption.

In some demonstrative embodiments, the security key corresponding to UE 102 may be derived based on one or more cellular security keys, for example, one or more LTE security keys, e.g., key K_{eNB}, e.g., as described above.

In some demonstrative embodiments, the security key corresponding to UE 102 may be derived, for example, using an Extensible Authentication Protocol (EAP)-PSK (EAP-PSK) authentication protocol, e.g., as defined in RFC 4764. In other embodiments, the security key corresponding to UE 102 may be derived according to any other additional or alternative protocols.

In some demonstrative embodiments, cellular node 104 and/or UE 102 may be configured to share with third parties, e.g., WLAN access device 104, keys, e.g., the UE security key, which may be derived from the cellular security keys. However, in some demonstrative embodiments, cellular node 104 and/or UE 102 may be configured to keep the cellular security keys, which are used to derive the UE security key, within a “secure environment” including cellular node 104 and UE 102, for example, in order not to compromise the security of the cellular security keys.

In some demonstrative embodiments, UE 102, node 104 and/or WLAN access device 106 may be configured to secure the WLAN link between UE 102 and WLAN access device 106 according to a fourth security scheme (“Solution 4”), e.g., as described below.

In some demonstrative embodiments, the “Solution 4” scheme may be configured to be implemented, for example, when LTE protocol stack aggregation is below the LTE PDCP layer.

In some demonstrative embodiments, UE 102, node 104 and/or WLAN access device 106 may be configured to secure the WLAN link between UE 102 and WLAN access device 106, for example, by re-using cellular encryption, e.g., LTE encryption, to secure the WLAN link, e.g., as described below.

In some demonstrative embodiments, UE 102 may associate with WLAN access device 106, for example, operating in an “open” authentication mode, which may be configured to operate without using authentication and/or WLAN encryption.

In some demonstrative embodiments, WLAN access device 106 and UE 102 may communicate PDCP Protocol Data Units (PDUs) over the WLAN link. The PDCP PDUs may be already encrypted, for example, using the cellular encryption, and may be transferred, e.g., tunneled or transferred in any other manner, between cellular node 104 and UE 102, for example, vie WLAN access device 106.

Some demonstrative embodiments are described herein with respect to communicating PDCP PDUs over the WLAN link. In other embodiments, any other PDUs may be communicated over the WLAN link, e.g., Radio Link Control (RLC) PDUs, MAC PDUs, or any other PDUs.

In some demonstrative embodiments, the “Solution 4” scheme may be advantageous, for example, as it may re-use of LTE security and/or may not involve CN signaling. However, the “Solution 4” scheme may not be able to provide WLAN authentication, and may enable a “rogue” STA to associate with the WLAN access device 106, e.g., unless additional measures are used to disable such associations.

In some demonstrative embodiments, UE 102, node 104 and/or WLAN access device 106 may be configured to secure the WLAN link between UE 102 and WLAN access device 106 according to a fifth security scheme (“Solution 5”), e.g., as described below.

In some demonstrative embodiments, the “Solution 5” scheme may be configured to be implemented, for example, when LTE protocol stack aggregation is below the LTE PDCP layer.

In some demonstrative embodiments, UE 102, node 104 and/or WLAN access device 106 may be configured to secure the WLAN link between UE 102 and WLAN access device 106, for example, by re-using cellular encryption, e.g., LTE encryption, to secure the WLAN link, for example, without performing association on the WLAN side, e.g., as described below.

In some demonstrative embodiments, cellular node 104 and UE 102 may be configured to establish a link between cellular node 104 and UE 102, e.g., via WLAN access device 106, for example, using enhanced RRC signaling or any other protocol.

In some demonstrative embodiments, WLAN access device 106 and UE 102 may establish a WLAN link, for example, without UE 102 performing association with WLAN access device 106.

In some demonstrative embodiments, after establishment of the link between UE 102 and cellular node 104 via WLAN access device 106, UE 102 and cellular node 104 may exchange messages via the WLAN link, for example, without WLAN authentication and association handshake.

In some demonstrative embodiments, WLAN access device 106 and UE 102 may communicate PDCP PDUs over the WLAN link. The PDCP PDUs may be already encrypted, for example, using the cellular encryption, and may be transferred between cellular node 104 and UE 102, for example, vie WLAN access device 106.

In some demonstrative embodiments, WLAN access device 106 and UE 102 may communicate the PDCP PDUs over the WLAN link, for example, without performing association between UE 102 and WLAN access device 106.

In some demonstrative embodiments, WLAN access device may be configured to communicate over the WLAN, for example, while association and/or authentication are disabled.

In some demonstrative embodiments, “rogue” STAs may not be able to connect to the coupled eNB/AP, for example, while the association and/or authentication are disabled.

In some demonstrative embodiments, cellular node 104 may be configured to provide to WLAN access device 106 information to indicate that UE 102 is to communicate with WLAN access device 106 at an unassociated and unauthenticated state.

In some demonstrative embodiments, controller 144 may cause interface 171 to send to WLAN access device a WLAN identifier of UE 102, and an indication that communication with UE 102 is to be performed at an unassociated and unauthenticated state.

In some demonstrative embodiments, interface 192 may receive from cellular node 104 the WLAN identifier of UE 102, and the indication that communication with UE 102 is to be performed at an unassociated and unauthenticated state.

In some demonstrative embodiments, controller 194 may be configured to, based on the WLAN identifier of UE 102 and the indication, cause WLAN transceiver 196 to communicate packets via an unassociated and unauthenticated link between WLAN transceiver 196 and UE 102. The packets may encapsulate communications between cellular manager 104 and the UE 102, e.g., as described above.

In some demonstrative embodiments, the WLAN identifier of the UE 102 may include, for example, a MAC address of the UE 102, an authentication identifier of the UE 102, or any other identifier to identify UE 102 in the WLAN.

In some demonstrative embodiments, controller 194 may be configured to allow only UEs, which are identified by cellular node 104, to communicate with WLAN access device 106.

In some demonstrative embodiments, controller 194 may be configured to cause the WLAN transceiver 196 to reject packets from a UE, for example, if a WLAN identifier of the UE is not received from cellular manager 104.

In some demonstrative embodiments, UE 102, cellular node 104, and/or WLAN access device 106 may be configured to utilize a dynamic WLAN MAC address white list mechanism, e.g., as described below.

In some demonstrative embodiments, dynamic WLAN MAC address white list mechanism may enable, for example, to enhance authentication capabilities of WLAN access device 106, for example, using a “dynamic” WLAN MAC address white list.

In some demonstrative embodiments, UE 102 may be configured to send the WLAN identifier of UE 102 to cellular node 104, for example, via a secure control protocol, e.g. enhanced RRC, or any other messaging or signaling protocol.

In some demonstrative embodiments, the WLAN identifier of UEs, which are connected to cellular node 104, e.g., UE 102, may be maintained in a list of WLAN identifiers, e.g., a dynamic WLAN MAC white list, which may be dynamically updated at WLAN access device 106.

In some demonstrative embodiments, WLAN access device 106 may be configured to accept WLAN packets, for example, only from UEs having a MAC address, which is on the white list.

In some demonstrative embodiments, controller 194 may be configured to manage a list of a plurality of WLAN identifiers received from cellular manager 104, e.g., as described above.

In some demonstrative embodiments, controller 194 may be configured to cause the WLAN transceiver 196 to accept packets only from UEs having the WLAN identifiers, which are on the list.

In some demonstrative embodiments, the “Solution 5” scheme may be advantageous, for example, as it may re-use of LTE security, may not involve CN signaling, may enable reduced WLAN connection time, e.g., by eliminating the WLAN authentication and association, and/or may prevent “rogue” STAs from connecting to the coupled eNB/AP. In some scenarios, the “Solution 4” scheme may involve changes to the functionality of the UE and/or WLAN Specifications.

In some demonstrative embodiments, UE 102, node 104 and/or WLAN access device 106 may be configured to secure the WLAN link between UE 102 and WLAN access device 106 according to a sixth security scheme (“Solution 6”), e.g., as described below.

In some demonstrative embodiments, the “Solution 6” scheme may be configured to be implemented, for example, when LTE protocol stack aggregation is below the LTE PDCP layer.

In some demonstrative embodiments, UE 102, node 104 and/or WLAN access device 106 may be configured to secure the WLAN link between UE 102 and WLAN access device 106, for example, by re-using cellular encryption, e.g., LTE encryption, to secure the WLAN link, e.g., as described below.

In some demonstrative embodiments, UE 102 may associate with WLAN access device 106, for example, operating in an “open” authentication mode, which may be configured to operate without using authentication and/or WLAN encryption.

In some demonstrative embodiments, WLAN access device 106 and UE 102 may communicate PDCP PDUs over the WLAN link. The PDCP PDUs may be already encrypted, for example, using the cellular encryption, and may be transferred, e.g., tunneled or transferred in any other manner, between cellular node 104 and UE 102, for example, vie WLAN access device 106.

In some demonstrative embodiments, cellular node 104 may be configured to perform a follow-up audit or confirmation of a UE connected to WLAN access device 106, for example, over a communication link (“the WLAN based link”) between cellular node 104 and UE 102 via WLAN access device 106, e.g., as described below.

In some demonstrative embodiments, the WLAN-based link between cellular node 104 and UE 102 via WLAN access device 106 may be established in the form of a concatenation of a link between node 104 and WLAN access device 106, and a link between WLAN access device 106 and UE 102.

In other embodiments, the WLAN-based link between cellular node 104 and UE 102 via WLAN access device 106 may be established in the form of a point-to-point link between UE 102 and cellular node 104, via WLAN access device 106.

In other embodiments, the WLAN-based link between cellular node 104 and UE 102 via WLAN access device 106 may be established in any other form.

In some demonstrative embodiments, the WLAN-based link between cellular node 104 and UE 102 via WLAN access device 106 may be established as a secure, e.g., encrypted link.

In some demonstrative embodiments, cellular node 104 may be configured to perform a follow-up authentication step between cellular node 104 and UE 102 over the WLAN-based link between cellular node 104 and UE 102 via WLAN access device 106.

In some demonstrative embodiments, cellular node 104 may share a secret key with the UE 102, for example, over the cellular link between UE 102 and cellular node 104, e.g., using RRC signaling and/or any other messages or signaling.

In some demonstrative embodiments, cellular node 104 may transfer, e.g., tunnel, the secret key over the encrypted WLAN-based link between cellular node 104 and UE 102 via WLAN access device 106.

In some demonstrative embodiments, only STAs for which the secret key is received correctly at the UE may be allowed to remain associated with the WLAN link. All “rogue” STAs would be forced to disassociate from the WLAN AP, if they have not been properly authenticated on the LTE side.

In some demonstrative embodiments, controller 144 may be configured to establish a WLAN-based link between cellular node 104 and UE 102, for example, via WLAN access device 106.

In some demonstrative embodiments, controller 144 may be configured to determine a UE verification key, and to send the UE verification key to UE via the cellular link.

In some demonstrative embodiments, controller 144 may cause cellular transceiver 167 to send to the UE 102 a RRC message including the UE verification key. In other embodiments, controller 144 may cause cellular transceiver 167 to send to the UE 102 any other message including the UE verification key.

In some demonstrative embodiments, cellular transceiver 165 may receive the UE verification key from cellular node 104.

In some demonstrative embodiments, controller 145 may be configured to establish the WLAN-based link between UE 102 and cellular node 104 via an associated and unauthenticated WLAN link between UE 102 and WLAN access device 1046, and to send the UE verification key to cellular node 104 via the point-to-point link.

In some demonstrative embodiments, controller 145 may be configured to send the UE verification key via the WLAN-based link within a predefined time period from establishing the WLAN-based link.

In some demonstrative embodiments, controller 144 may be configured to request WLAN access device 106 to disassociate from the UE 102, for example, if the UE verification key is not received from UE 102 via the WLAN-based link within the predefined time period.

In some demonstrative embodiments, UE 102, node 104 and/or WLAN access device 106 may be configured to secure the WLAN link between UE 102 and WLAN access device 106 according to a seventh security scheme (“Solution 7”), e.g., as described below.

In some demonstrative embodiments, the “Solution 7” scheme may be configured to be implemented, for example, when LTE protocol stack aggregation is below the LTE PDCP layer.

In some demonstrative embodiments, the “Solution 7” scheme may include combining one or more operations of the “Solution 5” scheme, for example, with WLAN authentication using a pre-shared key, e.g., as described below.

In some demonstrative embodiments, UE 102 may be configured to use the WPA method for authentication, wherein pre-shared keys of the WPA protocol may be generated and exchanged over the secure RRC link between the cellular node 104 and UE 102. The pre-shared keys of the WPA protocol may be made known to a co-located AP, e.g., WLAN access device 106, for example, through an internal interface, e.g., as described above.

In some demonstrative embodiments, a security weakness of WPA may not exposed, for example, since a distinct unique key may be used per UE, e.g., while not reusing the same key. The pre-shared keys may be regenerated and updated, for example, at any time, e.g., using the RRC link.

In some demonstrative embodiments, in some scenarios, implementations and/or use cases, some or all operations of two or more WLAN security schemes, e.g., two or more of the Solutions 1-7 described above, may be combined.

In one example, UE 102, cellular node 104, and/or WLAN access device 106 may be configured to use a WLAN security scheme, which may use LTE protocol stack aggregation below the LTE PDCP layer, may re-use LTE encryption, and may rely on WPA, e.g., WPA Enterprise as in Solution 1, or WPA PSK as in Solution 2, for authentication.

In another example, one or more operations of the “Solution 2” scheme or the “Solution 3” scheme may be used together with one or more operations of the “Solution 4” scheme, the “Solution 5” scheme, the “Solution 6” scheme and/or the “Solution 7” scheme. For example, such a combination may provide authentication, e.g., based on WPA, and encryption, e.g., based on LTE security.

In some demonstrative embodiments, WLAN access device 106 may be configured to operate at a WLAN “hidden mode”, for example, by not broadcasting an identifier of WLAN access device 106, e.g., a SSID of WLAN access device 106, for example, to enhance WLAN security. According to these embodiments, cellular node 104 may be configured to provide the WLAN identifier of WLAN access device to UE 102, for example, via enhanced RRC signaling.

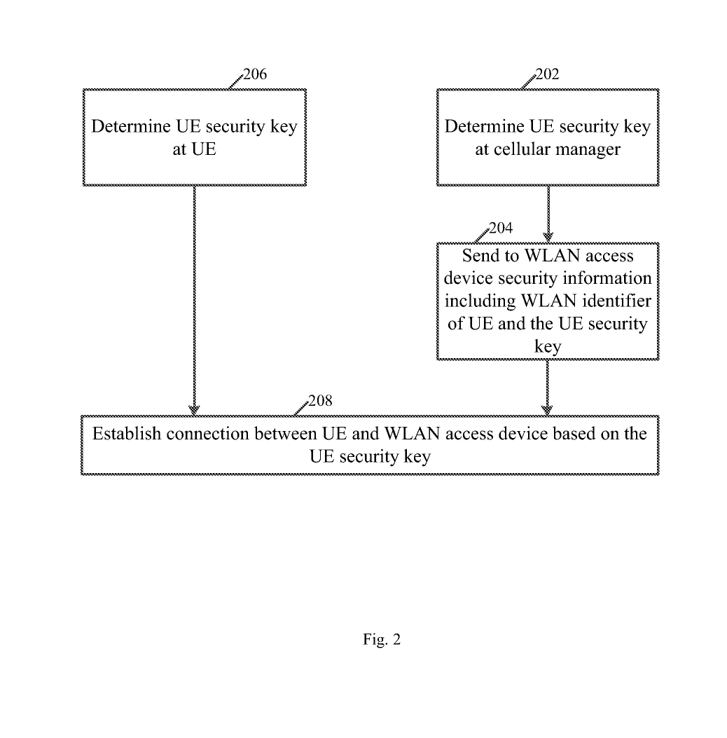

Reference is made to FIG. 2, which schematically illustrates a method of securing communications of a UE in a WLAN, in accordance with some demonstrative embodiments. In some embodiments, one or more of the operations of the method of FIG. 2 may be performed by system 100 (FIG. 1), UE 102 (FIG. 1), node 104 (FIG. 1), WLAN access device 106 (FIG. 1), controller 145 (FIG. 1), controller 144 (FIG. 1), and/or controller 194 (FIG. 1).

As indicated at block 202, the method may include determining at a cellular manager a UE security key based on a cellular security key corresponding to the cellular manager. For example, controller 144 (FIG. 1) may determine the UE security key based on a cellular security key corresponding to cellular node 104 (FIG. 1), e.g., as described above.

As indicated at block 204, the method may include sending to a WLAN access device security information corresponding to a UE, the security information including a WLAN identifier of the UE and the UE security key. For example, controller 144 (FIG. 1) may cause interface 171 to send to WLAN access device 106 (FIG. 1) the WLAN identifier of UE 102 (FIG. 1), and the UE security key, e.g., as described above.

As indicated at block 206, the method may include determining at the UE a UE security key based on the cellular security key corresponding to the cellular manager. For example, controller 145 (FIG. 1) may determine the UE security key based on the cellular security key corresponding to cellular node 104 (FIG. 1), e.g., as described above.

As indicated at block 208, the method may include establishing a connection between the UE and the WLAN access device based on the UE security key. For example, UE 102 and WLAN access device 106 may establish a WLAN connection between UE 102 and WLAN access device 106 based on the UE security key. For example, controller 14 5 (FIG. 1) and/or controller 194 (FIG. 1) may use the UE security key to authenticate UE 102 and/or to encrypt communications between UE 102 and WLAN access device 106, e.g., as described above.

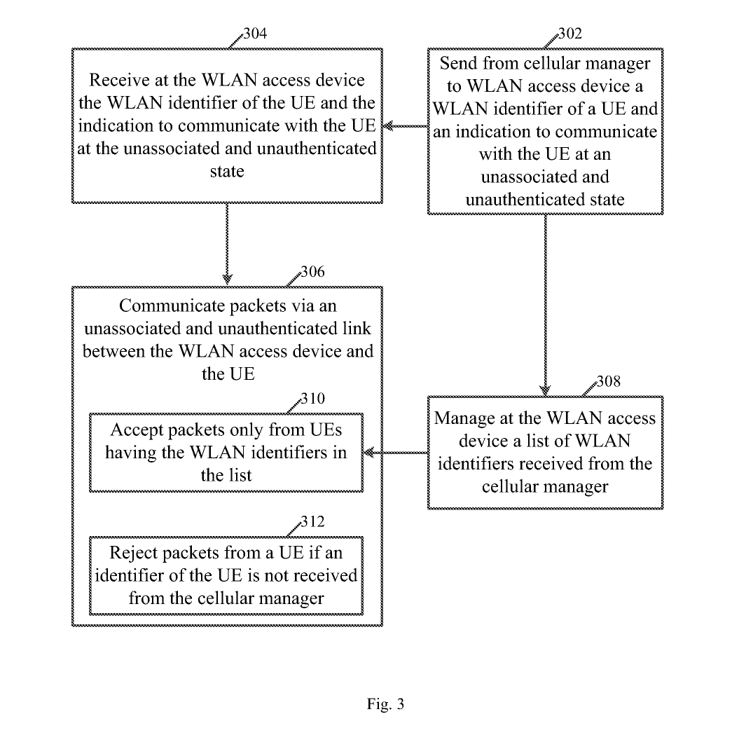

Reference is made to FIG. 3, which schematically illustrates a method of securing communications of a UE in a WLAN, in accordance with some demonstrative embodiments. In some embodiments, one or more of the operations of the method of FIG. 3 may be performed by system 100 (FIG. 1), UE 102 (FIG. 1), node 104 (FIG. 1), WLAN access device 106 (FIG. 1), controller 145 (FIG. 1), controller 144 (FIG. 1), and/or controller 194 (FIG. 1).

As indicated at block 302, the method may include sending from a cellular manager to a WLAN access device a WLAN identifier of a UE, and an indication that communication with the UE is to be performed at an unassociated and unauthenticated state. For example, controller 144 (FIG. 1) may cause interface 171 to send to WLAN access device 106 (FIG. 1) the WLAN identifier of UE 102 (FIG. 1), and an indication that communication with UE 102 (FIG. 1) is to be performed at an unassociated and unauthenticated state, e.g., as described above.

As indicated at block 304, the method may include receiving the WLAN identifier of the UE, and the indication that communication with the UE is to be performed at an unassociated and unauthenticated state. For example, interface 192 (FIG. 1) may receive from cellular node 104 (FIG. 1) the WLAN identifier of UE 102 (FIG. 1), and the indication that communication with UE 102 (FIG. 1) is to be performed at an unassociated and unauthenticated state, e.g., as described above.

As indicated at block 306, the method may communicating packets via an unassociated and unauthenticated link between the WLAN access device and the UE, the packets encapsulating communications between the cellular manager and the UE. For example, controller 194 (FIG. 1) may cause WLAN transceiver 196 (FIG. 1) to communicate packets via an unassociated and unauthenticated link between WLAN transceiver 196 (FIG. 1) and UE 102 (FIG. 1), the packets encapsulating communications between cellular node 104 (FIG. 1) and UE 102 (FIG. 1), e.g., as described above.

As indicated at block 308, the method may include managing a list of a plurality of WLAN identifiers received from the cellular manager. For example, controller 194 (FIG. 1) may manage a list (“whit list”) of a plurality of WLAN identifiers received from cellular node 104 (FIG. 1), e.g., as described above.

As indicated at block 310, the method may include accepting packets only from UEs having the WLAN identifiers in the list. For example, controller 194 (FIG. 1) may cause WLAN transceiver 196 (FIG. 1) to accept packets only from UEs having the WLAN identifiers in the white list, e.g., as described above.

As indicated at block 312, the method may include rejecting packets from a UE, if a WLAN identifier of the UE is not received from the cellular manager. For example, controller 194 (FIG. 1) may cause WLAN transceiver 196 (FIG. 1) to reject packets from a UE, if a WLAN identifier of the UE is not received from the cellular node 104 (FIG. 1).

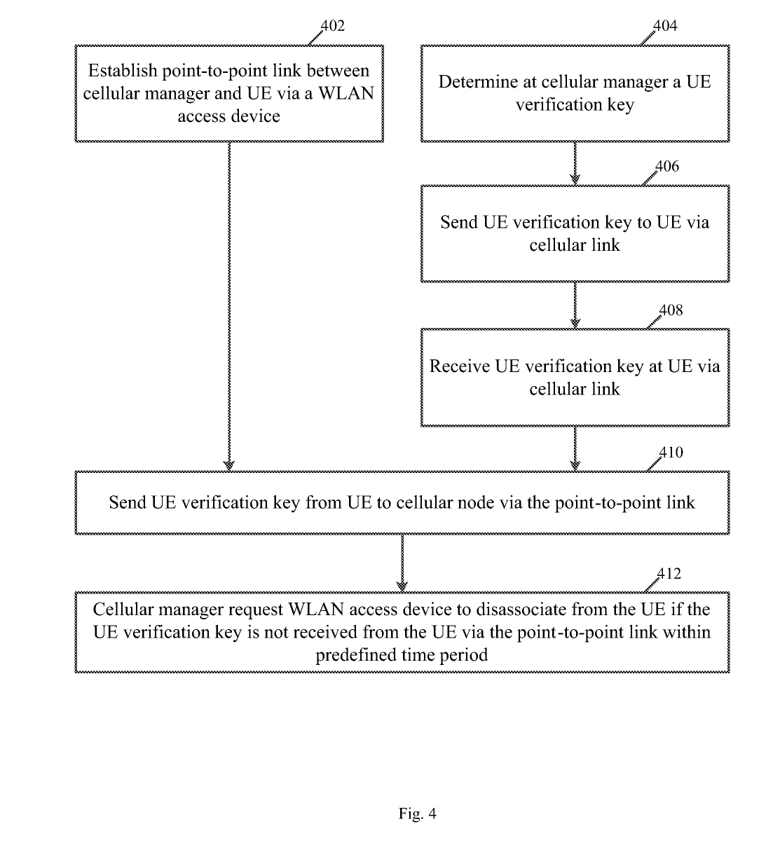

Reference is made to FIG. 4, which schematically illustrates a method of securing communications of a UE in a WLAN, in accordance with some demonstrative embodiments. In some embodiments, one or more of the operations of the method of FIG. 4 may be performed by system 100 (FIG. 1), UE 102 (FIG. 1), node 104 (FIG. 1), WLAN access device 106 (FIG. 1), controller 145 (FIG. 1), controller 144 (FIG. 1), and/or controller 194 (FIG. 1).

As indicated at block 402, the method may include establishing a WLAN-based link between a cellular manager and a UE via a WLAN access device. For example, controllers 144 (FIG. 1) and 145 (FIG. 1) may establish a WLAN-based link between cellular node 104 (FIG. 1) and UE 102 (FIG. 1) via WLAN access device 106 (FIG. 1), e.g., as described above.

As indicated at block 404, the method may include determining at the cellular manager a UE verification key. For example, controller 144 (FIG. 1) may determine a UE verification key, e.g., as described above.

As indicated at block 406, the method may include sending the UE verification key to the UE via a cellular link between the cellular manager and the UE. For example, controller 144 (FIG. 1) may cause cellular TRx 167 (FIG. 1) to transmit the UE verification key to UE 102 (FIG. 1), e.g., as described above.

As indicated at block 408, the method may include receiving the UE verification key from the cellular manager at the UE via the cellular link. For example, cellular TRx 165 (FIG. 1) to receive the UE verification key from cellular node 104 (FIG. 1), e.g., as described above.

In some demonstrative embodiments, the UE verification key may be communicated between the cellular manager and the UE after establishing the WLAN-based link. In other embodiments, the UE verification key may be communicated between the cellular manager and the UE before establishing the WLAN-based link.

As indicated at block 410, the method may include sending the UE verification key from the UE to the cellular node via the WLAN-based link. For example, controller 145 (FIG. 1) may cause WLAN TRx 163 to send the UE verification key to cellular node 104 (FIG. 1) via the WLAN-based link, e.g., as described above.

As indicated at block 412, the method may include requesting the WLAN access device to disassociate from the UE, for example, if the UE verification key is not received from the UE via the WLAN-based link within a predefined time period. For example, controller 144 (FIG. 1) may request WLAN access device 106 (FIG. 1) to disassociate from UE 102 (FIG. 1), for example, if the UE verification key is not received from UE 102 (FIG. 1) at cellular node 104 (FIG. 1) via the WLAN-based link, for example, within the predefined time period, e.g., as described above.

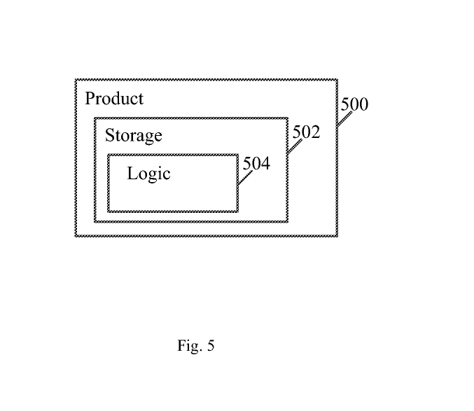

FIG. 5 is a schematic illustration of a product of manufacture, in accordance with some demonstrative embodiments. Product 500 may include a non-transitory machine-readable storage medium 502 to store logic 504, which may be used, for example, to perform at least part of the functionality of UE 102 (FIG. 1), node 104 (FIG. 1), WLAN access device 106 (FIG. 1), controller 144 (FIG. 1), controller 145, and/or controller 194 (FIG. 1), and/or to perform one or more operations of the methods of FIGS. 2, 3, and/or 4. The phrase “non-transitory machine-readable medium” is directed to include all computer-readable media, with the sole exception being a transitory propagating signal.

In some demonstrative embodiments, product 500 and/or machine-readable storage medium 502 may include one or more types of computer-readable storage media capable of storing data, including volatile memory, non-volatile memory, removable or non-removable memory, erasable or non-erasable memory, writeable or re-writeable memory, and the like. For example, machine-readable storage medium 502 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 504 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 504 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### Examples

The following examples pertain to further embodiments.

Example 1 includes a User Equipment (UE) comprising a Wireless Local Area Network (WLAN) transceiver; a cellular transceiver to communicate with an evolved Node B (eNB) of a cellular network; and a controller to determine a UE security key based on a cellular security key corresponding to the eNB, and to establish a connection with a WLAN access device based on the UE security key.

Example 2 includes the subject matter of Example 1, and optionally, wherein the cellular security key comprises an eNB security key (KeNB) corresponding to the eNB.

Example 3 includes the subject matter of Example 1 or 2, and optionally, wherein the controller is to determine the UE security key based on an identifier of the WLAN access device.

Example 4 includes the subject matter of Example 3, and optionally, wherein the identifier of the WLAN access device comprises a Media Access Control (MAC) address of the WLAN access device, or a Service Set Identifier (SSID) of the WLAN access device.

Example 5 includes the subject matter of Example 3 or 4, and optionally, wherein the cellular transceiver is to receive from the eNB a Radio Resource Control (RRC) message including the identifier of the WLAN access device.

Example 6 includes the subject matter of any one of Examples 1-5, and optionally, wherein the controller is to determine the UE security key based on an identifier of the UE.

Example 7 includes the subject matter of Example 6, and optionally, wherein the identifier of the UE comprises a Media Access Control (MAC) address of the UE.

Example 8 includes the subject matter of Example 6 or 7, and optionally, wherein the cellular transceiver is to send to the eNB a Radio Resource Control (RRC) message including the identifier of the UE.

Example 9 includes the subject matter of any one of Examples 1-8, and optionally, wherein the UE security key comprises a pre-shared key (PSK).

Example 10 includes the subject matter of Example 9, and optionally, wherein the PSK comprises a Wireless-Fidelity Protected Access (WPA) PSK.

Example 11 includes the subject matter of any one of Examples 1-10, and optionally, wherein the controller is to authenticate the UE with the WLAN access device based on the UE security key.

Example 12 includes the subject matter of any one of Examples 1-11, and optionally, wherein the controller is to encrypt communications with the WLAN access device based on the UE security key.

Example 13 includes the subject matter of any one of Examples 1-12, and optionally, comprising one or more antennas, a memory and a processor.

Example 14 includes an evolved Node B (eNB) comprising a cellular transceiver to communicate with a User Equipment (UE) via a cellular link; a controller to determine a UE security key based on a cellular security key corresponding to the eNB; and an access device interface to send to a Wireless Local Area Network (WLAN) access device security information corresponding to the UE, the security information including a WLAN identifier of the UE and the UE security key.

Example 15 includes the subject matter of Example 14, and optionally, wherein the cellular security key comprises an eNB security key (KeNB) corresponding to the eNB.

Example 16 includes the subject matter of Example 14 or 15, and optionally, wherein the controller is to determine the UE security key based on an identifier of the WLAN access device.

Example 17 includes the subject matter of Example 16, and optionally, wherein the identifier of the WLAN access device comprises a Media Access Control (MAC) address of the WLAN access device, or a Service Set Identifier (SSID) of the WLAN access device.

Example 18 includes the subject matter of Example 16 or 17, and optionally, wherein the cellular transceiver is to send to the UE a Radio Resource Control (RRC) message including the identifier of the WLAN access device.

Example 19 includes the subject matter of any one of Examples 14-18, and optionally, wherein the controller is to determine the UE security key based on an identifier of the UE.

Example 20 includes the subject matter of Example 19, and optionally, wherein the identifier of the UE comprises a Media Access Control (MAC) address of the UE.

Example 21 includes the subject matter of Example 19 or 20, and optionally, wherein the cellular transceiver is to receive from the UE a Radio Resource Control (RRC) message including the identifier of the UE.

Example 22 includes the subject matter of any one of Examples 14-21, and optionally, wherein the UE security key comprises a pre-shared key (PSK).

Example 23 includes the subject matter of Example 22, and optionally, wherein the PSK comprises a Wireless-Fidelity Protected Access (WPA) PSK.

Example 24 includes the subject matter of any one of Examples 14-23 being integrated with the WLAN access device as part of an integrated eNB Access Point (AP) (eNB/AP).

Example 25 includes the subject matter of any one of Examples 14-24, and optionally, comprising one or more antennas, a memory, and a processor.

Example 26 includes a system of wireless communication, the system comprising Evolved Node B (eNB) circuitry to determine a User Equipment (UE) security key corresponding to a UE based on a cellular security key corresponding to the eNB; and Wireless Local Area Network (WLAN) access device circuitry to receive from the eNB circuitry security information including the UE security key, the WLAN access device circuitry to establish a WLAN link with the UE based on the UE security key.

Example 27 includes the subject matter of Example 26, and optionally, wherein the cellular security key comprises an eNB security key (KeNB) corresponding to the eNB.

Example 28 includes the subject matter of Example 26 or 27, and optionally, wherein the eNB circuitry is to determine the UE security key based on a WLAN access device identifier.

Example 29 includes the subject matter of Example 28, and optionally, wherein the WLAN access device identifier comprises a WLAN access device Media Access Control (MAC) address, or a WLAN access device Service Set Identifier (SSID).

Example 30 includes the subject matter of Example 28 or 29, and optionally, wherein the eNB circuitry is to send to the UE a Radio Resource Control (RRC) message including the WLAN access device identifier.

Example 31 includes the subject matter of any one of Examples 26-30, and optionally, wherein the eNB circuitry is to determine the UE security key based on an identifier of the UE.

Example 32 includes the subject matter of Example 31, and optionally, wherein the identifier of the UE comprises a Media Access Control (MAC) address of the UE.

Example 33 includes the subject matter of Example 31 or 32, and optionally, wherein the eNB circuitry is to receive from the UE a Radio Resource Control (RRC) message including the identifier of the UE.

Example 34 includes the subject matter of any one of Examples 26-33, and optionally, wherein the UE security key comprises a pre-shared key (PSK).

Example 35 includes the subject matter of Example 34, and optionally, wherein the PSK comprises a Wireless-Fidelity Protected Access (WPA) PSK.

Example 36 includes the subject matter of any one of Example 26-35, and optionally, comprising one or more antennas, a memory, and a processor.

Example 37 includes a Wireless Local Area Network (WLAN) access device comprising a WLAN transceiver; a cellular manager interface to receive from a cellular manager a WLAN identifier of a User Equipment (UE), and an indication that communication with the UE is to be performed at an unassociated and unauthenticated state; and a controller to cause the WLAN transceiver to communicate packets via an unassociated and unauthenticated link between the WLAN transceiver and the UE, the packets encapsulating communications between the cellular manager and the UE.

Example 38 includes the subject matter of Example 37, and optionally, wherein the controller is to manage a list of a plurality of WLAN identifiers received from the cellular manager, the controller to cause the WLAN transceiver to accept packets only from UEs having the WLAN identifiers.

Example 39 includes the subject matter of Example 37 or 38, and optionally, wherein the controller is to cause the WLAN transceiver to reject packets from another UE, if a WLAN identifier of the another UE is not received from the cellular manager.

Example 40 includes the subject matter of any one of Examples 37-39, and optionally, wherein the WLAN identifier of the UE comprises a Media Access Control (MAC) address of the UE, or an authentication identifier of the UE.

Example 41 includes the subject matter of any one of Examples 37-40 being integrated with the eNB access device as part of an integrated eNB Access Point (AP) (eNB/AP).

Example 42 includes the subject matter of any one of Examples 37-41, and optionally, comprising one or more antennas, a memory and a processor.

Example 43 includes a User Equipment (UE) comprising a Wireless Local Area Network (WLAN) transceiver; a cellular transceiver to receive a UE verification key from an evolved Node B (eNB) of a cellular network; and a controller to establish a WLAN-based link between the UE and the eNB via an associated and unauthenticated WLAN link between the UE and a WLAN access device, and to send the UE verification key to the eNB via the WLAN-based link.

Example 44 includes the subject matter of Example 43, and optionally, wherein the cellular transceiver is to receive a Radio Resource Control (RRC) message including the UE verification key.

Example 45 includes the subject matter of Example 43 or 44, and optionally, wherein the controller is to send the UE verification key via the WLAN-based link within a predefined time period from establishing the WLAN-based link.

Example 46 includes the subject matter of any one of Examples 43-45, and optionally, comprising one or more antennas, a memory and a processor.

Example 47 includes an evolved Node B (eNB) comprising a cellular transceiver to communicate with a User Equipment (UE) via a cellular link; an access device interface to communicate with a Wireless Local Area Network (WLAN) access device; and a controller to establish a WLAN-based link between the eNB and the UE via the WLAN access device, the controller to determine a UE verification key, to send the UE verification key to the UE via the cellular link, and to request the WLAN access device to disassociate from the UE, if the UE verification key is not received from the UE via the WLAN-based link within a predefined time period.

Example 48 includes the subject matter of Example 47, and optionally, wherein the cellular transceiver is to send to the UE a Radio Resource Control (RRC) message including the UE verification key.

Example 49 includes the subject matter of Example 47 or 48 being integrated with the WLAN access device as part of an integrated eNB Access Point (AP) (eNB/AP).

Example 50 includes the subject matter of any one of Examples 47-49, and optionally, comprising one or more antennas, a memory and a processor.

Example 51 includes a method to be performed by a User Equipment (UE), the method comprising communicating with an evolved Node B (eNB) of a cellular network; determining a UE security key based on a cellular security key corresponding to the eNB; and establishing a connection with a Wireless Local Area Network (WLAN) access device based on the UE security key.

Example 52 includes the subject matter of Example 51, and optionally, wherein the cellular security key comprises an eNB security key (KeNB) corresponding to the eNB.

Example 53 includes the subject matter of Example 51 or 52, and optionally, comprising determining the UE security key based on an identifier of the WLAN access device.

Example 54 includes the subject matter of Example 53, and optionally, wherein the identifier of the WLAN access device comprises a Media Access Control (MAC) address of the WLAN access device, or a Service Set Identifier (SSID) of the WLAN access device.

Example 55 includes the subject matter of Example 53 or 54, and optionally, comprising receiving from the eNB a Radio Resource Control (RRC) message including the identifier of the WLAN access device.

Example 56 includes the subject matter of any one of Examples 51-55, and optionally, comprising determining the UE security key based on an identifier of the UE.

Example 57 includes the subject matter of Example 56, and optionally, wherein the identifier of the UE comprises a Media Access Control (MAC) address of the UE.

Example 58 includes the subject matter of Example 56 or 57, and optionally, comprising sending to the eNB a Radio Resource Control (RRC) message including the identifier of the UE.

Example 59 includes the subject matter of any one of Examples 51-58, and optionally, wherein the UE security key comprises a pre-shared key (PSK).

Example 60 includes the subject matter of Example 59, and optionally, wherein the PSK comprises a Wireless-Fidelity Protected Access (WPA) PSK.

Example 61 includes the subject matter of any one of Examples 51-60, and optionally, comprising authenticating the UE with the WLAN access device based on the UE security key.

Example 62 includes the subject matter of any one of Examples 51-61, and optionally, comprising encrypting communications with the WLAN access device based on the UE security key.

Example 63 includes a method to be performed at an evolved Node B (eNB), the method comprising communicating with a User Equipment (UE) via a cellular link; determining a UE security key based on a cellular security key corresponding to the eNB; and sending to a Wireless Local Area Network (WLAN) access device security information corresponding to the UE, the security information including a WLAN identifier of the UE and the UE security key.

Example 64 includes the subject matter of Example 63, and optionally, wherein the cellular security key comprises an eNB security key (KeNB) corresponding to the eNB.

Example 65 includes the subject matter of Example 63 or 64, and optionally, comprising determining the UE security key based on an identifier of the WLAN access device.

Example 66 includes the subject matter of Example 65, and optionally, wherein the identifier of the WLAN access device comprises a Media Access Control (MAC) address of the WLAN access device, or a Service Set Identifier (SSID) of the WLAN access device.

Example 67 includes the subject matter of Example 65 or 66, and optionally, comprising sending to the UE a Radio Resource Control (RRC) message including the identifier of the WLAN access device.

Example 68 includes the subject matter of any one of Examples 63-67, and optionally, comprising determining the UE security key based on an identifier of the UE.

Example 69 includes the subject matter of Example 68, and optionally, wherein the identifier of the UE comprises a Media Access Control (MAC) address of the UE.

Example 70 includes the subject matter of Example 68 or 69, and optionally, comprising receiving from the UE a Radio Resource Control (RRC) message including the identifier of the UE.

Example 71 includes the subject matter of any one of Examples 63-70, and optionally, wherein the UE security key comprises a pre-shared key (PSK).

Example 72 includes the subject matter of Example 71, and optionally, wherein the PSK comprises a Wireless-Fidelity Protected Access (WPA) PSK.

Example 73 includes a method to be performed at a system of wireless communication, the method comprising determining at an Evolved Node B (eNB) a User Equipment (UE) security key corresponding to a UE based on a cellular security key corresponding to the eNB; providing to a Wireless Local Area Network (WLAN) access device security information including the UE security key; and at the WLAN access device, establishing a WLAN link with the UE based on the UE security key.

Example 74 includes the subject matter of Example 73, and optionally, wherein the cellular security key comprises an eNB security key (KeNB) corresponding to the eNB.

Example 75 includes the subject matter of Example 73 or 74, and optionally, comprising determining the UE security key based on a WLAN access device identifier.

Example 76 includes the subject matter of Example 75, and optionally, wherein the WLAN access device identifier comprises a WLAN access device Media Access Control (MAC) address, or a WLAN access device Service Set Identifier (SSID).

Example 77 includes the subject matter of Example 75 or 76, and optionally, comprising sending to the UE a Radio Resource Control (RRC) message including the WLAN access device identifier.

Example 78 includes the subject matter of any one of Examples 73-77, and optionally, comprising determining the UE security key based on an identifier of the UE.

Example 79 includes the subject matter of Example 78, and optionally, wherein the identifier of the UE comprises a Media Access Control (MAC) address of the UE.

Example 80 includes the subject matter of Example 78 or 79, and optionally, comprising receiving from the UE a Radio Resource Control (RRC) message including the identifier of the UE.

Example 81 includes the subject matter of any one of Examples 73-80, and optionally, wherein the UE security key comprises a pre-shared key (PSK).

Example 82 includes the subject matter of Example 81, and optionally, wherein the PSK comprises a Wireless-Fidelity Protected Access (WPA) PSK.

Example 83 includes a method to be performed at a Wireless Local Area Network (WLAN) access device, the method comprising receiving from a cellular manager a WLAN identifier of a User Equipment (UE), and an indication that communication with the UE is to be performed at an unassociated and unauthenticated state; and communicating packets via an unassociated and unauthenticated link between the WLAN transceiver and the UE, the packets encapsulating communications between the cellular manager and the UE.

Example 84 includes the subject matter of Example 83, and optionally, comprising managing a list of a plurality of WLAN identifiers received from the cellular manager, and accepting packets only from UEs having the WLAN identifiers.

Example 85 includes the subject matter of Example 83 or 84, and optionally, comprising rejecting packets from another UE, if a WLAN identifier of the another UE is not received from the cellular manager.

Example 86 includes the subject matter of any one of Examples 83-85, and optionally, wherein the WLAN identifier of the UE comprises a Media Access Control (MAC) address of the UE, or an authentication identifier of the UE.

Example 87 includes a method to be performed at a User Equipment (UE), the method comprising receiving a UE verification key from an evolved Node B (eNB) of a cellular network; establishing a Wireless Local Area Network (WLAN) based link between the UE and the eNB via an associated and unauthenticated WLAN link between the UE and a WLAN access device; and sending the UE verification key to the eNB via the WLAN-based link.

Example 88 includes the subject matter of Example 87, and optionally, comprising receiving a Radio Resource Control (RRC) message including the UE verification key.

Example 89 includes the subject matter of Example 87 or 88, and optionally, comprising sending the UE verification key via the WLAN-based link within a predefined time period from establishing the WLAN-based link.

Example 90 includes a method to be performed at an evolved Node B (eNB), the method comprising communicating with a User Equipment (UE) via a cellular link; communicating with a Wireless Local Area Network (WLAN) access device; establishing a WLAN-based link between the eNB and the UE via the WLAN access device; determining a UE verification key; sending the UE verification key to the UE via the cellular link; and requesting the WLAN access device to disassociate from the UE, if the UE verification key is not received from the UE via the WLAN-based link within a predefined time period.

Example 91 includes the subject matter of Example 90, and optionally, comprising sending to the UE a Radio Resource Control (RRC) message including the UE verification key.

Example 92 includes a product including one or more tangible computer-readable non-transitory storage media comprising computer-executable instructions operable to, when executed by at least one computer processor, enable the at least one computer processor to implement a method at a User Equipment (UE), the method comprising communicating with an evolved Node B (eNB) of a cellular network; determining a UE security key based on a cellular security key corresponding to the eNB; and establishing a connection with a Wireless Local Area Network (WLAN) access device based on the UE security key.

Example 93 includes the subject matter of Example 92, and optionally, wherein the cellular security key comprises an eNB security key (KeNB) corresponding to the eNB.

Example 94 includes the subject matter of Example 92 or 93, and optionally, wherein the method comprises determining the UE security key based on an identifier of the WLAN access device.

Example 95 includes the subject matter of Example 94, and optionally, wherein the identifier of the WLAN access device comprises a Media Access Control (MAC) address of the WLAN access device, or a Service Set Identifier (SSID) of the WLAN access device.

Example 96 includes the subject matter of Example 94 or 95, and optionally, wherein the method comprises receiving from the eNB a Radio Resource Control (RRC) message including the identifier of the WLAN access device.

Example 97 includes the subject matter of any one of Examples 92-96, and optionally, wherein the method comprises determining the UE security key based on an identifier of the UE.

Example 98 includes the subject matter of Example 97, and optionally, wherein the identifier of the UE comprises a Media Access Control (MAC) address of the UE.

Example 99 includes the subject matter of Example 97 or 98, and optionally, wherein the method comprises sending to the eNB a Radio Resource Control (RRC) message including the identifier of the UE.

Example 100 includes the subject matter of any one of Examples 92-99, and optionally, wherein the UE security key comprises a pre-shared key (PSK).

Example 101 includes the subject matter of Example 100, and optionally, wherein the PSK comprises a Wireless-Fidelity Protected Access (WPA) PSK.

Example 102 includes the subject matter of any one of Examples 92-101, and optionally, wherein the method comprises authenticating the UE with the WLAN access device based on the UE security key.

Example 103 includes the subject matter of any one of Examples 92-102, and optionally, wherein the method comprises encrypting communications with the WLAN access device based on the UE security key.

Example 104 includes a product including one or more tangible computer-readable non-transitory storage media comprising computer-executable instructions operable to, when executed by at least one computer processor, enable the at least one computer processor to implement a method at an evolved Node B (eNB), the method comprising communicating with a User Equipment (UE) via a cellular link; determining a UE security key based on a cellular security key corresponding to the eNB; and sending to a Wireless Local Area Network (WLAN) access device security information corresponding to the UE, the security information including a WLAN identifier of the UE and the UE security key.

Example 105 includes the subject matter of Example 104, and optionally, wherein the cellular security key comprises an eNB security key (KeNB) corresponding to the eNB.

Example 106 includes the subject matter of Example 104 or 105, and optionally, wherein the method comprises determining the UE security key based on an identifier of the WLAN access device.

Example 107 includes the subject matter of Example 106, and optionally, wherein the identifier of the WLAN access device comprises a Media Access Control (MAC) address of the WLAN access device, or a Service Set Identifier (SSID) of the WLAN access device.

Example 108 includes the subject matter of Example 106 or 107, and optionally, wherein the method comprises sending to the UE a Radio Resource Control (RRC) message including the identifier of the WLAN access device.

Example 109 includes the subject matter of any one of Examples 104-108, and optionally, wherein the method comprises determining the UE security key based on an identifier of the UE.

Example 110 includes the subject matter of Example 109, and optionally, wherein the identifier of the UE comprises a Media Access Control (MAC) address of the UE.

Example 111 includes the subject matter of Example 109 or 110, and optionally, wherein the method comprises receiving from the UE a Radio Resource Control (RRC) message including the identifier of the UE.

Example 112 includes the subject matter of any one of Examples 104-111, and optionally, wherein the UE security key comprises a pre-shared key (PSK).

Example 113 includes the subject matter of Example 112, and optionally, wherein the PSK comprises a Wireless-Fidelity Protected Access (WPA) PSK.

Example 114 includes a product including one or more tangible computer-readable non-transitory storage media comprising computer-executable instructions operable to, when executed by at least one computer processor, enable the at least one computer processor to implement a method at a system of wireless communication, the method comprising determining at an Evolved Node B (eNB) a User Equipment (UE) security key corresponding to a UE based on a cellular security key corresponding to the eNB; providing to a Wireless Local Area Network (WLAN) access device security information including the UE security key; and at the WLAN access device, establishing a WLAN link with the UE based on the UE security key.

Example 115 includes the subject matter of Example 114, and optionally, wherein the cellular security key comprises an eNB security key (KeNB) corresponding to the eNB.

Example 116 includes the subject matter of Example 114 or 115, and optionally, wherein the method comprises determining the UE security key based on a WLAN access device identifier.

Example 117 includes the subject matter of Example 116, and optionally, wherein the WLAN access device identifier comprises a WLAN access device Media Access Control (MAC) address, or a WLAN access device Service Set Identifier (SSID).

Example 118 includes the subject matter of Example 116 or 117, and optionally, wherein the method comprises sending to the UE a Radio Resource Control (RRC) message including the WLAN access device identifier.

Example 119 includes the subject matter of any one of Examples 114-118, and optionally, wherein the method comprises determining the UE security key based on an identifier of the UE.

Example 120 includes the subject matter of Example 119, and optionally, wherein the identifier of the UE comprises a Media Access Control (MAC) address of the UE.

Example 121 includes the subject matter of Example 119 or 120, and optionally, wherein the method comprises receiving from the UE a Radio Resource Control (RRC) message including the identifier of the UE.

Example 122 includes the subject matter of any one of Examples 114-121, and optionally, wherein the UE security key comprises a pre-shared key (PSK).

Example 123 includes the subject matter of Example 122, and optionally, wherein the PSK comprises a Wireless-Fidelity Protected Access (WPA) PSK.

Example 124 includes a product including one or more tangible computer-readable non-transitory storage media comprising computer-executable instructions operable to, when executed by at least one computer processor, enable the at least one computer processor to implement a method at a Wireless Local Area Network (WLAN) access device, the method comprising receiving from a cellular manager a WLAN identifier of a User Equipment (UE), and an indication that communication with the UE is to be performed at an unassociated and unauthenticated state; and communicating packets via an unassociated and unauthenticated link between the WLAN transceiver and the UE, the packets encapsulating communications between the cellular manager and the UE.

Example 125 includes the subject matter of Example 124, and optionally, wherein the method comprises managing a list of a plurality of WLAN identifiers received from the cellular manager, and accepting packets only from UEs having the WLAN identifiers.

Example 126 includes the subject matter of Example 124 or 125, and optionally, wherein the method comprises rejecting packets from another UE, if a WLAN identifier of the another UE is not received from the cellular manager.

Example 127 includes the subject matter of any one of Examples 124-126, and optionally, wherein the WLAN identifier of the UE comprises a Media Access Control (MAC) address of the UE, or an authentication identifier of the UE.

Example 128 includes a product including one or more tangible computer-readable non-transitory storage media comprising computer-executable instructions operable to, when executed by at least one computer processor, enable the at least one computer processor to implement a method at a User Equipment (UE), the method comprising receiving a UE verification key from an evolved Node B (eNB) of a cellular network; establishing a Wireless Local Area Network (WLAN) based link between the UE and the eNB via an associated and unauthenticated WLAN link between the UE and a WLAN access device; and sending the UE verification key to the eNB via the WLAN-based link.

Example 129 includes the subject matter of Example 128, and optionally, wherein the method comprises receiving a Radio Resource Control (RRC) message including the UE verification key.

Example 130 includes the subject matter of Example 128 or 129, and optionally, wherein the method comprises sending the UE verification key via the WLAN-based link within a predefined time period from establishing the WLAN-based link.

Example 131 includes a product including one or more tangible computer-readable non-transitory storage media comprising computer-executable instructions operable to, when executed by at least one computer processor, enable the at least one computer processor to implement a method at an evolved Node B (eNB), the method comprising communicating with a User Equipment (UE) via a cellular link; communicating with a Wireless Local Area Network (WLAN) access device; establishing a WLAN-based link between the eNB and the UE via the WLAN access device; determining a UE verification key; sending the UE verification key to the UE via the cellular link; and requesting the WLAN access device to disassociate from the UE, if the UE verification key is not received from the UE via the WLAN-based link within a predefined time period.

Example 132 includes the subject matter of Example 131, and optionally, wherein the method comprises sending to the UE a Radio Resource Control (RRC) message including the UE verification key.

Example 133 includes an apparatus of a User Equipment (UE), the apparatus comprising means for communicating with an evolved Node B (eNB) of a cellular network; means for determining a UE security key based on a cellular security key corresponding to the eNB; and means for establishing a connection with a Wireless Local Area Network (WLAN) access device based on the UE security key.

Example 134 includes the subject matter of Example 133, and optionally, wherein the cellular security key comprises an eNB security key (KeNB) corresponding to the eNB.

Example 135 includes the subject matter of Example 133 or 134, and optionally, comprising means for determining the UE security key based on an identifier of the WLAN access device.

Example 136 includes the subject matter of Example 135, and optionally, wherein the identifier of the WLAN access device comprises a Media Access Control (MAC) address of the WLAN access device, or a Service Set Identifier (SSID) of the WLAN access device.

Example 137 includes the subject matter of Example 135 or 136, and optionally, comprising means for receiving from the eNB a Radio Resource Control (RRC) message including the identifier of the WLAN access device.

Example 138 includes the subject matter of any one of Examples 133-137, and optionally, comprising means for determining the UE security key based on an identifier of the UE.

Example 139 includes the subject matter of Example 138, and optionally, wherein the identifier of the UE comprises a Media Access Control (MAC) address of the UE.

Example 140 includes the subject matter of Example 139, and optionally, comprising means for sending to the eNB a Radio Resource Control (RRC) message including the identifier of the UE.

Example 141 includes the subject matter of any one of Examples 133-140, and optionally, wherein the UE security key comprises a pre-shared key (PSK).

Example 142 includes the subject matter of Example 141, and optionally, wherein the PSK comprises a Wireless-Fidelity Protected Access (WPA) PSK.

Example 143 includes the subject matter of any one of Examples 133-142, and optionally, comprising means for authenticating the UE with the WLAN access device based on the UE security key.

Example 144 includes the subject matter of any one of Examples 133-143, and optionally, comprising means for encrypting communications with the WLAN access device based on the UE security key.

Example 145 includes an apparatus of an evolved Node B (eNB), the apparatus comprising means for communicating with a User Equipment (UE) via a cellular link; means for determining a UE security key based on a cellular security key corresponding to the eNB; and means for sending to a Wireless Local Area Network (WLAN) access device security information corresponding to the UE, the security information including a WLAN identifier of the UE and the UE security key.

Example 146 includes the subject matter of Example 145, and optionally, wherein the cellular security key comprises an eNB security key (KeNB) corresponding to the eNB.

Example 147 includes the subject matter of Example 145 or 146, and optionally, comprising means for determining the UE security key based on an identifier of the WLAN access device.

Example 148 includes the subject matter of Example 147, and optionally, wherein the identifier of the WLAN access device comprises a Media Access Control (MAC) address of the WLAN access device, or a Service Set Identifier (SSID) of the WLAN access device.

Example 149 includes the subject matter of Example 147 or 148, and optionally, comprising means for sending to the UE a Radio Resource Control (RRC) message including the identifier of the WLAN access device.

Example 150 includes the subject matter of any one of Examples 145-149, and optionally, comprising means for determining the UE security key based on an identifier of the UE.

Example 151 includes the subject matter of Example 150, and optionally, wherein the identifier of the UE comprises a Media Access Control (MAC) address of the UE.

Example 152 includes the subject matter of Example 150 or 151, and optionally, comprising means for receiving from the UE a Radio Resource Control (RRC) message including the identifier of the UE.

Example 153 includes the subject matter of anyone of Examples 145-152, and optionally, wherein the UE security key comprises a pre-shared key (PSK).

Example 154 includes the subject matter of Example 153, and optionally, wherein the PSK comprises a Wireless-Fidelity Protected Access (WPA) PSK.

Example 155 includes an apparatus of wireless communication, the apparatus comprising means for determining at an Evolved Node B (eNB) a User Equipment (UE) security key corresponding to a UE based on a cellular security key corresponding to the eNB; means for providing to a Wireless Local Area Network (WLAN) access device security information including the UE security key; and means for, at the WLAN access device, establishing a WLAN link with the UE based on the UE security key.

Example 156 includes the subject matter of Example 155, and optionally, wherein the cellular security key comprises an eNB security key (KeNB) corresponding to the eNB.

Example 157 includes the subject matter of Example 155 or 156, and optionally, comprising means for determining the UE security key based on a WLAN access device identifier.

Example 158 includes the subject matter of Example 157, and optionally, wherein the WLAN access device identifier comprises a WLAN access device Media Access Control (MAC) address, or a WLAN access device Service Set Identifier (SSID).

Example 159 includes the subject matter of any one of Examples 155-158, and optionally, comprising means for sending to the UE a Radio Resource Control (RRC) message including the WLAN access device identifier.

Example 160 includes the subject matter of any one of Examples 155-159, and optionally, comprising means for determining the UE security key based on an identifier of the UE.

Example 161 includes the subject matter of Example 160, and optionally, wherein the identifier of the UE comprises a Media Access Control (MAC) address of the UE.

Example 162 includes the subject matter of Example 160 or 161, and optionally, comprising means for receiving from the UE a Radio Resource Control (RRC) message including the identifier of the UE.

Example 163 includes the subject matter of any one of Examples 155-162, and optionally, wherein the UE security key comprises a pre-shared key (PSK).

Example 164 includes the subject matter of Example 163, and optionally, wherein the PSK comprises a Wireless-Fidelity Protected Access (WPA) PSK.

Example 165 includes an apparatus of a Wireless Local Area Network (WLAN) access device, the apparatus comprising means for receiving from a cellular manager a WLAN identifier of a User Equipment (UE), and an indication that communication with the UE is to be performed at an unassociated and unauthenticated state; and means for communicating packets via an unassociated and unauthenticated link between the WLAN transceiver and the UE, the packets encapsulating communications between the cellular manager and the UE.

Example 166 includes the subject matter of Example 165, and optionally, comprising means for managing a list of a plurality of WLAN identifiers received from the cellular manager, and accepting packets only from UEs having the WLAN identifiers.

Example 167 includes the subject matter of Example 165 or 166, and optionally, comprising means for rejecting packets from another UE, if a WLAN identifier of the another UE is not received from the cellular manager.

Example 168 includes the subject matter of any one of Examples 165-167, and optionally, wherein the WLAN identifier of the UE comprises a Media Access Control (MAC) address of the UE, or an authentication identifier of the UE.

Example 169 includes an apparatus of a User Equipment (UE), the apparatus comprising means receiving a UE verification key from an evolved Node B (eNB) of a cellular network; means for establishing a Wireless Local Area Network (WLAN) based link between the UE and the eNB via an associated and unauthenticated link between the UE and a WLAN access device; and means for sending the UE verification key to the eNB via the WLAN-based link.

Example 170 includes the subject matter of Example 169, and optionally, comprising means for receiving a Radio Resource Control (RRC) message including the UE verification key.

Example 171 includes the subject matter of Example 169 or 170, and optionally, comprising means for sending the UE verification key via the WLAN-based link within a predefined time period from establishing the WLAN-based link.

Example 172 includes an apparatus of an evolved Node B (eNB), the apparatus comprising means for communicating with a User Equipment (UE) via a cellular link; means for communicating with a Wireless Local Area Network (WLAN) access device; means for establishing a WLAN-based link between the eNB and the UE via the WLAN access device; means for determining a UE verification key; means for sending the UE verification key to the UE via the cellular link; and means for requesting the WLAN access device to disassociate from the UE, if the UE verification key is not received from the UE via the WLAN-based link within a predefined time period.

Example 173 includes the subject matter of Example 172, and optionally, comprising means for sending to the UE a Radio Resource Control (RRC) message including the UE verification key.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1.-22. (canceled)

23. A User Equipment (UE) comprising:
a Wireless Local Area Network (WLAN) transceiver;
a cellular transceiver to communicate with an evolved Node B (eNB) of a cellular network; and
a controller to determine a UE security key based on a cellular security key corresponding to the eNB, and to establish a connection with a WLAN access device based on the UE security key.

24. The UE of claim 23, wherein said cellular security key comprises an eNB security key (K_{eNB}) corresponding to the eNB.

25. The UE of claim 23, wherein said controller is to determine the UE security key based on an identifier of the WLAN access device.

26. The UE of claim 25, wherein the identifier of the WLAN access device comprises a Media Access Control (MAC) address of the WLAN access device, or a Service Set Identifier (SSID) of the WLAN access device.

27. The UE of claim 25, wherein the cellular transceiver is to receive from the eNB a Radio Resource Control (RRC) message including the identifier of the WLAN access device.

28. The UE of claim 23, wherein said controller is to determine the UE security key based on an identifier of the UE.

29. The UE of claim 28, wherein the cellular transceiver is to send to the eNB a Radio Resource Control (RRC) message including the identifier of the UE.

30. The UE of claim 23, wherein the UE security key comprises a pre-shared key (PSK).

31. The UE of claim 23, wherein said controller is to authenticate said UE with said WLAN access device based on the UE security key.

32. The UE of claim 23, wherein said controller is to encrypt communications with said WLAN access device based on the UE security key.

33. The UE of claim 23 comprising one or more antennas, a memory and a processor.

34. An evolved Node B (eNB) comprising:
a cellular transceiver to communicate with a User Equipment (UE) via a cellular link;
a controller to determine a UE security key based on a cellular security key corresponding to the eNB; and
an access device interface to send to a Wireless Local Area Network (WLAN) access device security information corresponding to the UE, the security information including a WLAN identifier of the UE and the UE security key.

35. The eNB of claim 34, wherein said cellular security key comprises an eNB security key (K_{eNB}) corresponding to the eNB.

36. The eNB of claim 34, wherein said controller is to determine the UE security key based on an identifier of the WLAN access device.

37. The eNB of claim 36, wherein the cellular transceiver is to send to the UE a Radio Resource Control (RRC) message including the identifier of the WLAN access device.

38. The eNB of claim 34, wherein said controller is to determine the UE security key based on an identifier of the UE.

39. The eNB of claim 38, wherein the cellular transceiver is to receive from the UE a Radio Resource Control (RRC) message including the identifier of the UE.

40. The eNB of claim 34 being integrated with said WLAN access device as part of an integrated eNB Access Point (AP) (eNB/AP).

41. The eNB of claim 34 comprising one or more antennas, a memory, and a processor.

42. A Wireless Local Area Network (WLAN) access device comprising:
a WLAN transceiver;
a cellular manager interface to receive from a cellular manager a WLAN identifier of a User Equipment (UE), and an indication that communication with the UE is to be performed at an unassociated and unauthenticated state; and
a controller to cause the WLAN transceiver to communicate packets via an unassociated and unauthenticated link between the WLAN transceiver and the UE, the packets encapsulating communications between the cellular manager and the UE.

43. The WLAN access device of claim 42, wherein the controller is to manage a list of a plurality of WLAN identifiers received from the cellular manager, the controller to cause the WLAN transceiver to accept packets only from UEs having said WLAN identifiers.

44. The WLAN access device of claim 42, wherein the controller is to cause the WLAN transceiver to reject packets from another UE, if a WLAN identifier of the another UE is not received from the cellular manager.

45. A User Equipment (UE) comprising:
a Wireless Local Area Network (WLAN) transceiver;
a cellular transceiver to receive a UE verification key from an evolved Node B (eNB) of a cellular network; and
a controller to establish a WLAN-based link between the UE and the eNB via an associated and unauthenticated WLAN link between the UE and a WLAN access device, and to send the UE verification key to the eNB via the WLAN-based link.

46. The UE of claim 45, wherein said cellular transceiver is to receive a Radio Resource Control (RRC) message including the UE verification key.

47. The UE of claim 45, wherein said controller is to send the UE verification key via the WLAN-based link within a predefined time period from establishing the WLAN-based link.
